(19) United States
(12) Patent Application Publication
(10) Pub. No.: US 2025/0379937 A1
(43) Pub. Date: Dec. 11, 2025

(54) AUDIO RECORDING AND TRANSCRIPTION

(71) Applicant: Apple Inc., Cupertino, CA (US)

(72) Inventors: Jae Woo CHANG, Los Altos Hills, CA (US); Markus HAGELE, San Francisco, CA (US); Ping Tsung LI, San Mateo, CA (US); Joanna M. NEWMAN, San Jose, CA (US); Merilou G. SALAZAR, Buena Park, CA (US)

(21) Appl. No.: 19/030,511

(22) Filed: Jan. 17, 2025

Related U.S. Application Data
(60) Provisional application No. 63/657,822, filed on Jun. 8, 2024.
(60) Provisional application No. 63/670,680, filed on Jul. 12, 2024.

(51) Int. Cl. H04M 3/42; G06F 3/0484

(52) U.S. Cl. CPC H04M 3/42221; G06F 3/0484

(57) ABSTRACT

The present disclosure generally relates to audio recording and transcription. A method includes, while the computer system is connected to a telephone call, displaying, via the one or more display generation components, a telephone call user interface. The method includes, while displaying the telephone call user interface, in accordance with a determination that archival option criteria are met, displaying, via the one or more display generation components, an option for archiving the telephone call. The method includes detecting, via the one or more input devices, an input directed to the option for archiving the telephone call, and in response to detecting the input directed to the option for archiving the telephone call, initiating a process for creating an archive based on audio corresponding to the telephone call.

### CROSS-REFERENCE TO RELATED APPLICATIONS

This application claims priority to U.S. Provisional Application No. 63/670,680, entitled “AUDIO RECORDING AND TRANSCRIPTION,” filed Jul. 12, 2024, and U.S. Provisional Application No. 63/657,822, entitled “AUDIO RECORDING AND TRANSCRIPTION,” filed Jun. 8, 2024, the entire contents of which are hereby incorporated by reference.

### FIELD

The present disclosure relates generally to computer user interfaces, and more specifically to techniques for audio recording and transcription.

### BACKGROUND

Electronic devices include displays that can be used to display various types of content and to provide information to a user. Some electronic devices, such as smartphones, can display interfaces for audio recording and transcription.

### BRIEF SUMMARY

Some techniques for audio recording and transcription using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for audio recording and transcription. Such methods and interfaces optionally complement or replace other methods for audio recording and transcription. Such methods and interfaces reduce the cognitive burden on a user and produce a more efficient human-machine interface. For battery-operated computing devices, such methods and interfaces conserve power and increase the time between battery charges.

In accordance with some embodiments, a method is described. The method comprises: at a computer system that is in communication with one or more display generation components and one or more input devices: while the computer system is connected to a telephone call, displaying, via the one or more display generation components, a telephone call user interface; while displaying the telephone call user interface, in accordance with a determination that archival option criteria are met, displaying, via the one or more display generation components, an option for archiving the telephone call; and detecting, via the one or more input devices, an input directed to the option for archiving the telephone call; and in response to detecting the input directed to the option for archiving the telephone call, initiating a process for creating an archive based on audio corresponding to the telephone call.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: while the computer system is connected to a telephone call, displaying, via the one or more display generation components, a telephone call user interface; while displaying the telephone call user interface, in accordance with a determination that archival option criteria are met, displaying, via the one or more display generation components, an option for archiving the telephone call; and detecting, via the one or more input devices, an input directed to the option for archiving the telephone call; and in response to detecting the input directed to the option for archiving the telephone call, initiating a process for creating an archive based on audio corresponding to the telephone call.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: while the computer system is connected to a telephone call, displaying, via the one or more display generation components, a telephone call user interface; while displaying the telephone call user interface, in accordance with a determination that archival option criteria are met, displaying, via the one or more display generation components, an option for archiving the telephone call; and detecting, via the one or more input devices, an input directed to the option for archiving the telephone call; and in response to detecting the input directed to the option for archiving the telephone call, initiating a process for creating an archive based on audio corresponding to the telephone call.

In accordance with some embodiments, a computer system configured to communicate with one or more display generation components and one or more input devices, comprising: one or more processors; and memory storing one or more programs configured to be executed by the one or more processors, the one or more programs including instructions for: while the computer system is connected to a telephone call, displaying, via the one or more display generation components, a telephone call user interface; while displaying the telephone call user interface, in accordance with a determination that archival option criteria are met, displaying, via the one or more display generation components, an option for archiving the telephone call; and detecting, via the one or more input devices, an input directed to the option for archiving the telephone call; and in response to detecting the input directed to the option for archiving the telephone call, initiating a process for creating an archive based on audio corresponding to the telephone call.

In accordance with some embodiments, a computer system configured to communicate with a display generation component is described. The computer system comprises: while the computer system is connected to a telephone call, means for displaying, via the one or more display generation components, a telephone call user interface; while displaying the telephone call user interface, in accordance with a determination that archival option criteria are met, means for displaying, via the one or more display generation components, an option for archiving the telephone call; and means for detecting, via the one or more input devices, an input directed to the option for archiving the telephone call; and in response to detecting the input directed to the option for archiving the telephone call, means for initiating a process for creating an archive based on audio corresponding to the telephone call.

In accordance with some embodiments, a computer program product is described. The computer program product comprises one or more programs configured to be executed by one or more processors of a computer system that is in communication with a display generation component, the one or more programs including instructions for: while the computer system is connected to a telephone call, displaying, via the one or more display generation components, a telephone call user interface; while displaying the telephone call user interface, in accordance with a determination that archival option criteria are met, displaying, via the one or more display generation components, an option for archiving the telephone call; and detecting, via the one or more input devices, an input directed to the option for archiving the telephone call; and in response to detecting the input directed to the option for archiving the telephone call, initiating a process for creating an archive based on audio corresponding to the telephone call.

In accordance with some embodiments, a method is described. The method comprises: at a computer system that is in communication with one or more display generation components and one or more input devices: detecting, via the one or more input devices, an input directed to an option to record audio, wherein the option to record audio is displayed within a file; in response to detecting the input directed to the option to record audio, displaying, via the one or more display generation components, an option to initiate an audio recording; detecting, via the one or more input devices, an input directed to the option to initiate an audio recording; and in response to detecting the input directed to the option to initiate an audio recording, initiating the audio recording.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: detecting, via the one or more input devices, an input directed to an option to record audio, wherein the option to record audio is displayed within a file; in response to detecting the input directed to the option to record audio, displaying, via the one or more display generation components, an option to initiate an audio recording; detecting, via the one or more input devices, an input directed to the option to initiate an audio recording; and in response to detecting the input directed to the option to initiate an audio recording, initiating the audio recording.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: detecting, via the one or more input devices, an input directed to an option to record audio, wherein the option to record audio is displayed within a file; in response to detecting the input directed to the option to record audio, displaying, via the one or more display generation components, an option to initiate an audio recording; detecting, via the one or more input devices, an input directed to the option to initiate an audio recording; and in response to detecting the input directed to the option to initiate an audio recording, initiating the audio recording.

In accordance with some embodiments, a computer system configured to communicate with one or more display generation components and one or more input devices, comprising: one or more processors; and memory storing one or more programs configured to be executed by the one or more processors, the one or more programs including instructions for: detecting, via the one or more input devices, an input directed to an option to record audio, wherein the option to record audio is displayed within a file; in response to detecting the input directed to the option to record audio, displaying, via the one or more display generation components, an option to initiate an audio recording; detecting, via the one or more input devices, an input directed to the option to initiate an audio recording; and in response to detecting the input directed to the option to initiate an audio recording, initiating the audio recording.

In accordance with some embodiments, a computer system configured to communicate with a display generation component is described. The computer system comprises: means for detecting, via the one or more input devices, an input directed to an option to record audio, wherein the option to record audio is displayed within a file; in response to detecting the input directed to the option to record audio, means for displaying, via the one or more display generation components, an option to initiate an audio recording; means for detecting, via the one or more input devices, an input directed to the option to initiate an audio recording; and in response to detecting the input directed to the option to initiate an audio recording, means for initiating the audio recording.

In accordance with some embodiments, a computer program product is described. The computer program product comprises one or more programs configured to be executed by one or more processors of a computer system that is in communication with a display generation component, the one or more programs including instructions for: detecting, via the one or more input devices, an input directed to an option to record audio, wherein the option to record audio is displayed within a file; in response to detecting the input directed to the option to record audio, displaying, via the one or more display generation components, an option to initiate an audio recording; detecting, via the one or more input devices, an input directed to the option to initiate an audio recording; and in response to detecting the input directed to the option to initiate an audio recording, initiating the audio recording.

In accordance with some embodiments, a method is described. The method comprises: at a computer system that is in communication with one or more display generation components and one or more input devices: displaying, via the one or more display generation components, a file including a user interface element with an option to play an audio recording; detecting, via the one or more input devices, an input directed to the user interface element; and in response to detecting the input directed to the user interface element, displaying, via the one or more display generation components, a user interface corresponding to the audio recording.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: displaying, via the one or more display generation components, a file including a user interface element with an option to play an audio recording; detecting, via the one or more input devices, an input directed to the user interface element; and in response to detecting the input directed to the user interface element, displaying, via the one or more display generation components, a user interface corresponding to the audio recording.

In accordance with some embodiments, a transitory computer-readable storage medium is described. The transitory computer-readable storage medium stores one or more programs configured to be executed by one or more processors of a computer system that is in communication with one or more display generation components and one or more input devices, the one or more programs including instructions for: displaying, via the one or more display generation components, a file including a user interface element with an option to play an audio recording; detecting, via the one or more input devices, an input directed to the user interface element; and in response to detecting the input directed to the user interface element, displaying, via the one or more display generation components, a user interface corresponding to the audio recording.

In accordance with some embodiments, a computer system configured to communicate with one or more display generation components and one or more input devices, comprising: one or more processors; and memory storing one or more programs configured to be executed by the one or more processors, the one or more programs including instructions for: displaying, via the one or more display generation components, a file including a user interface element with an option to play an audio recording; detecting, via the one or more input devices, an input directed to the user interface element; and in response to detecting the input directed to the user interface element, displaying, via the one or more display generation components, a user interface corresponding to the audio recording.

In accordance with some embodiments, a computer system configured to communicate with a display generation component is described. The computer system comprises: means for displaying, via the one or more display generation components, a file including a user interface element with an option to play an audio recording; means for detecting, via the one or more input devices, an input directed to the user interface element; and in response to detecting the input directed to the user interface element, means for displaying, via the one or more display generation components, a user interface corresponding to the audio recording.

In accordance with some embodiments, a computer program product is described. The computer program product comprises one or more programs configured to be executed by one or more processors of a computer system that is in communication with a display generation component, the one or more programs including instructions for: displaying, via the one or more display generation components, a file including a user interface element with an option to play an audio recording; detecting, via the one or more input devices, an input directed to the user interface element; and in response to detecting the input directed to the user interface element, displaying, via the one or more display generation components, a user interface corresponding to the audio recording.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for audio recording and transcription, thereby increasing the effectiveness, efficiency, and user satisfaction with such devices. Such methods and interfaces may complement or replace other methods for audio recording and transcription.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6U illustrate techniques for audio recording and transcription, in accordance with some embodiments.

FIG. 7 is a flow diagram illustrating methods for audio recording and transcription, in accordance with some embodiments.

FIGS. 8A-8U illustrate techniques for audio recording and transcription, in accordance with some embodiments.

FIGS. 9-10 are flow diagrams illustrating methods for audio recording and transcription, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for audio recording and transcription. For instance, options to initiate recording and/or transcription or a telephone call or of environmental audio are provided within a note file. Such techniques can reduce the cognitive burden on a user who uses audio recording and transcriptions, thereby enhancing productivity. Further, such techniques can reduce processor and battery power otherwise wasted on redundant user inputs.

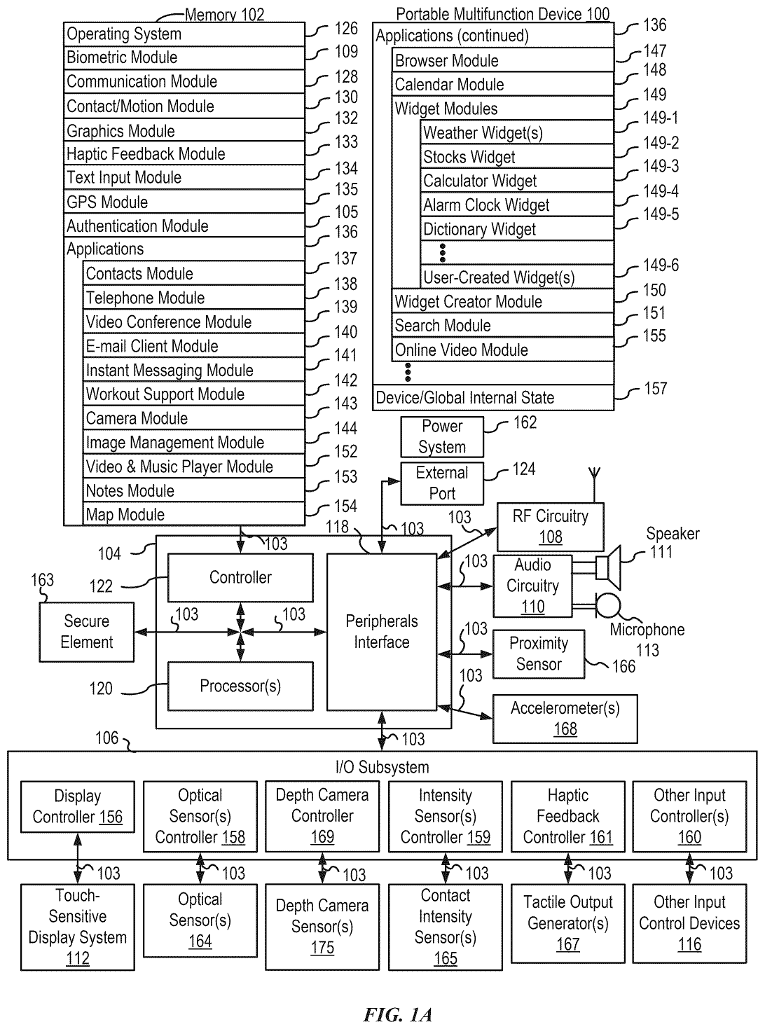

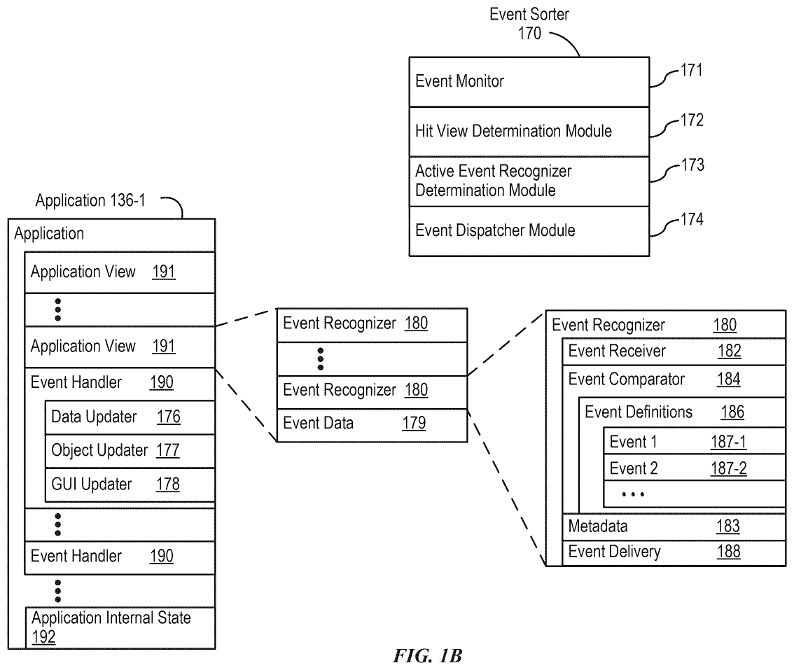

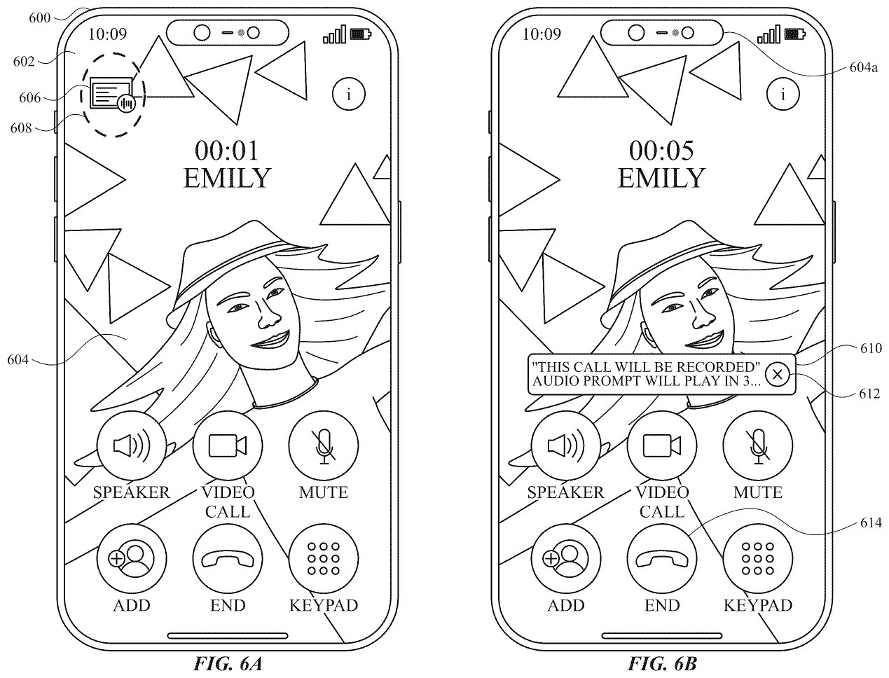

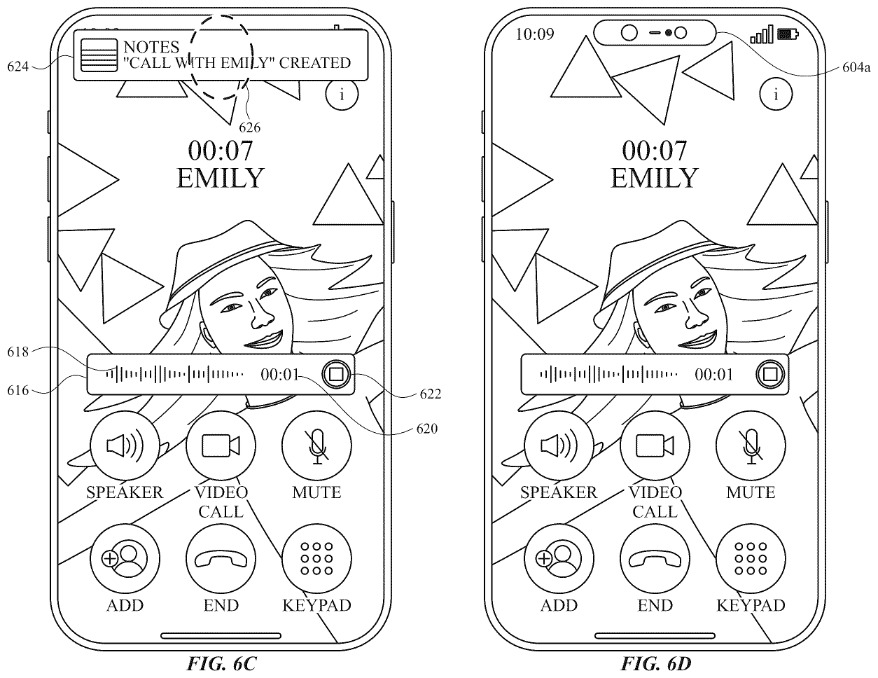

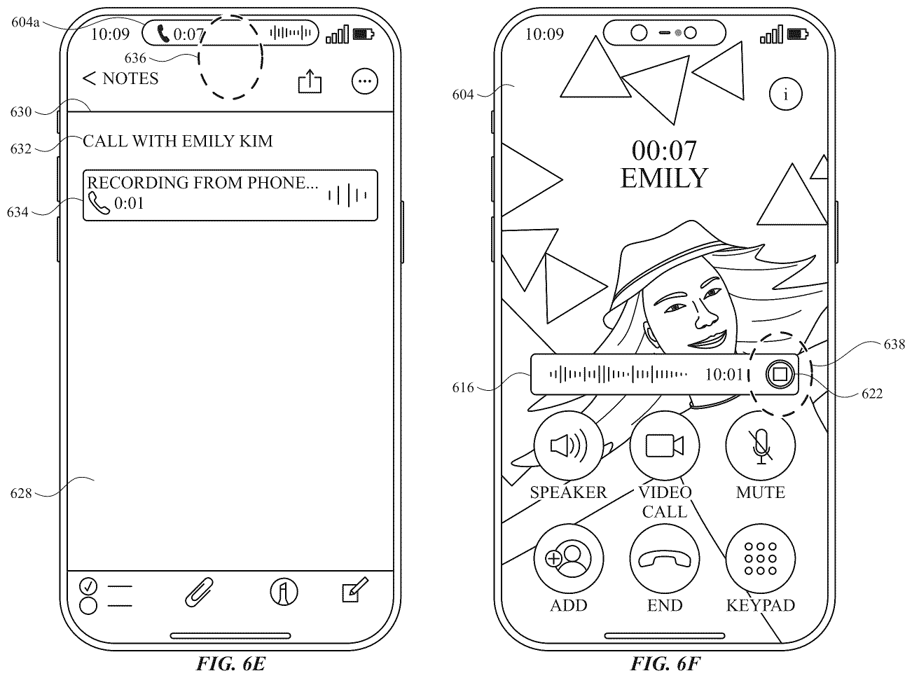

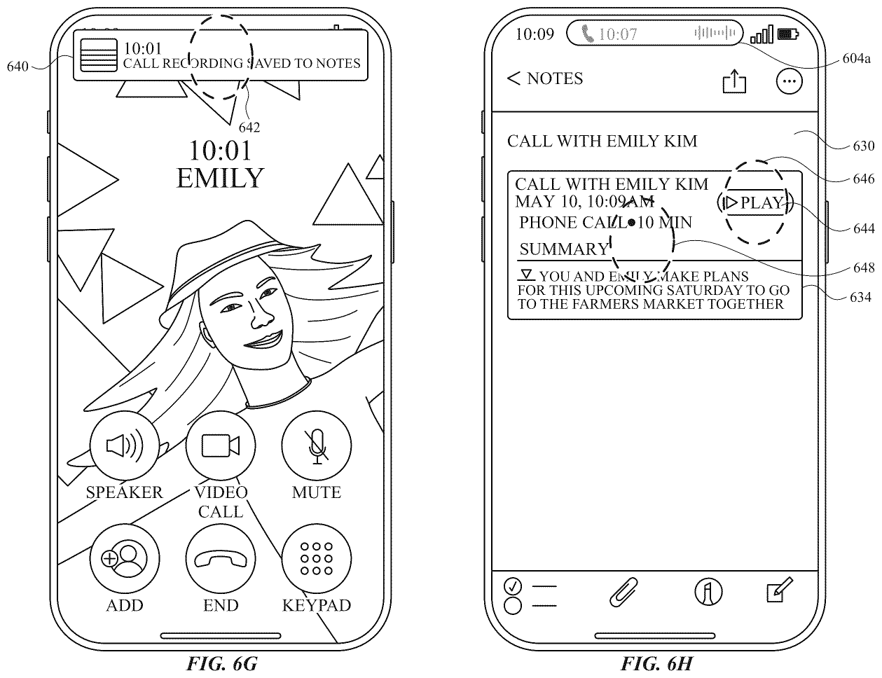

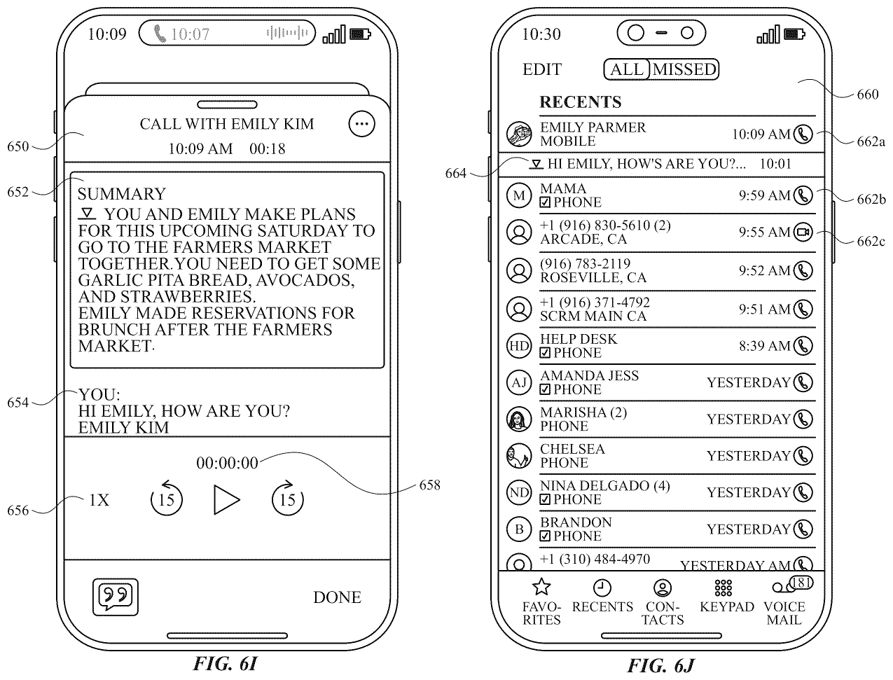

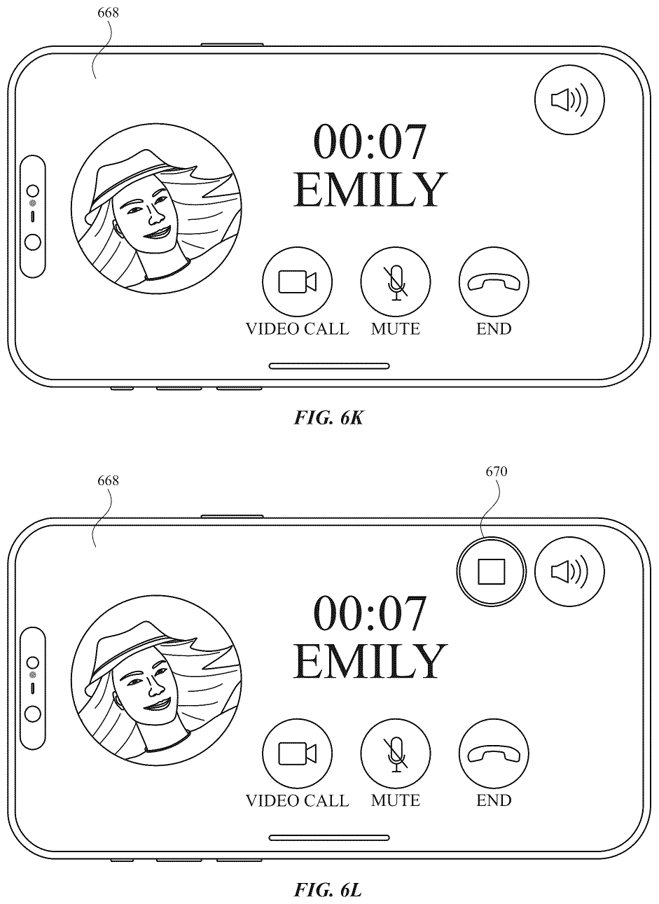

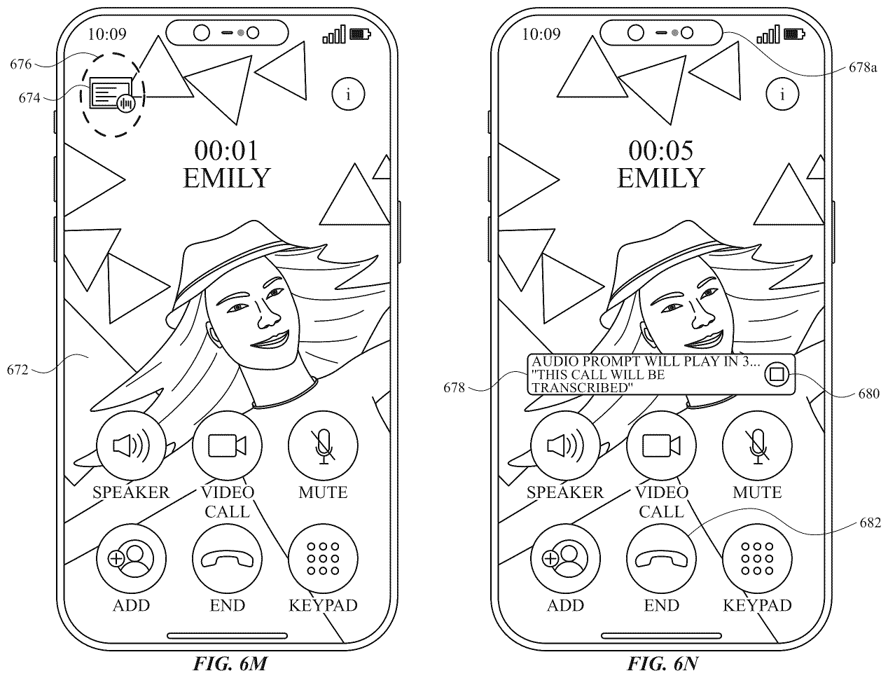

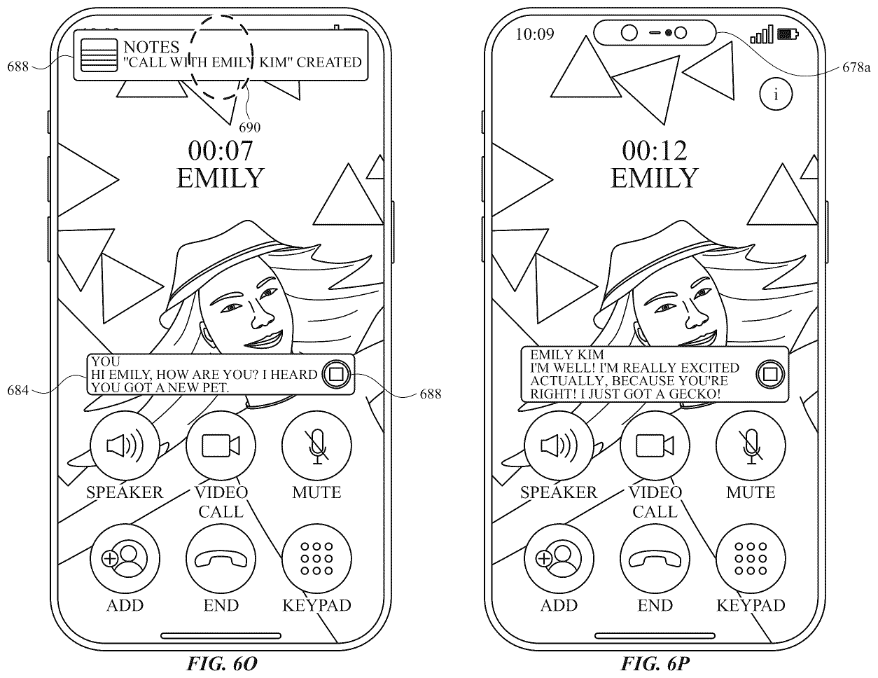

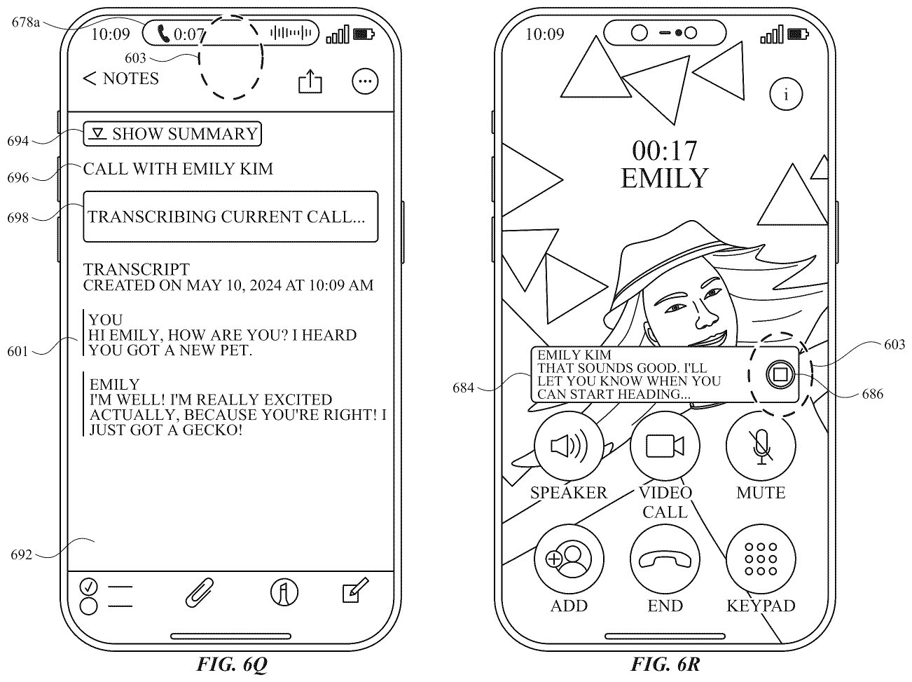

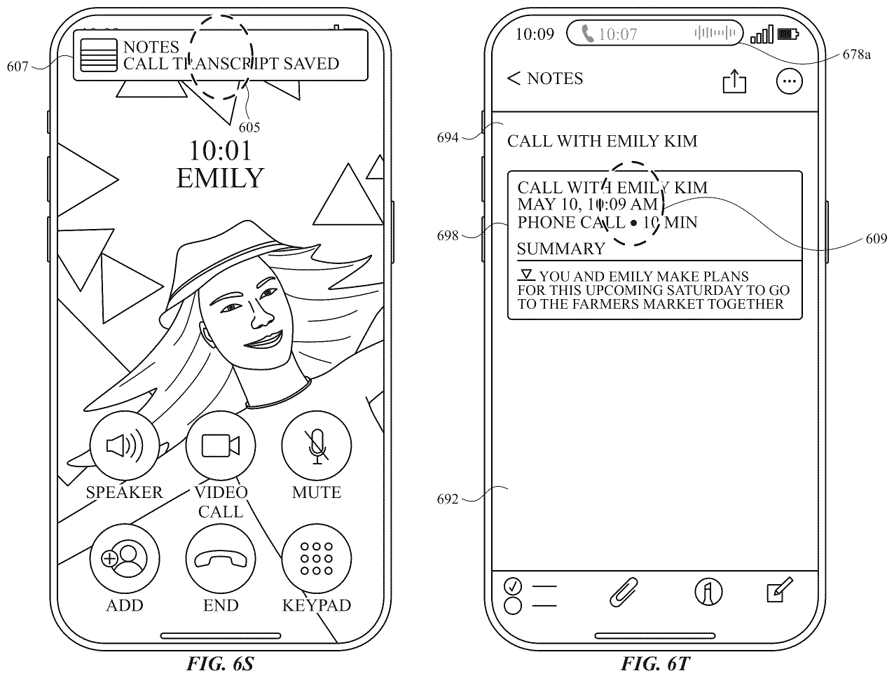

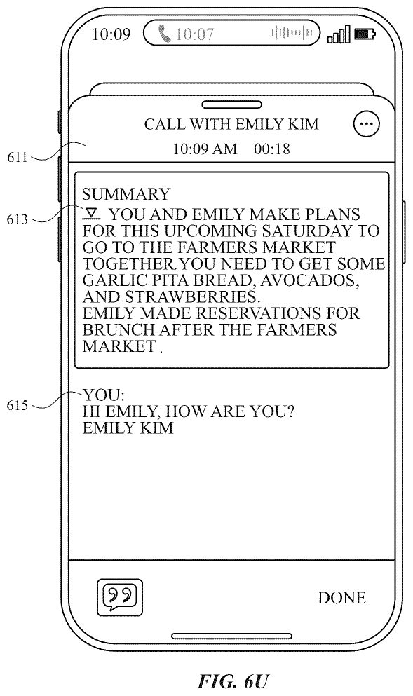

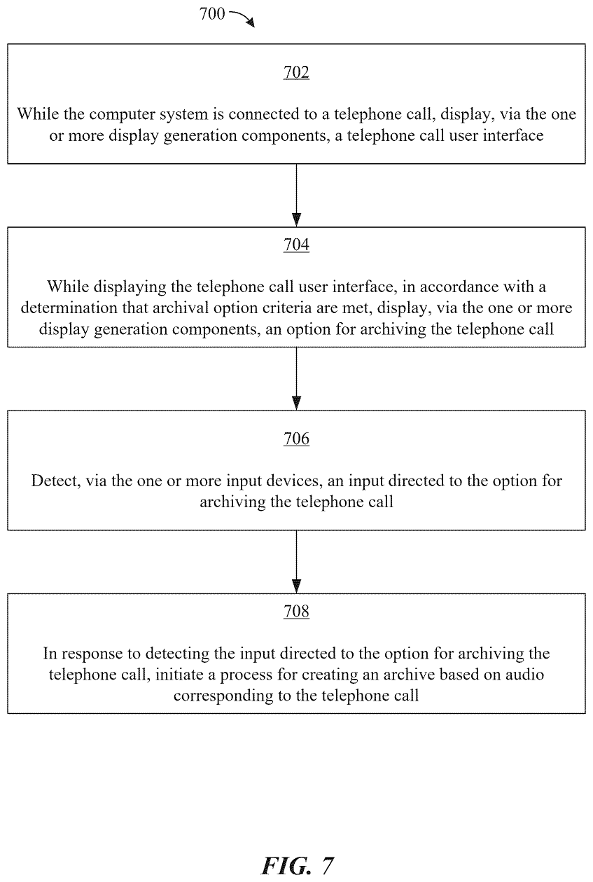

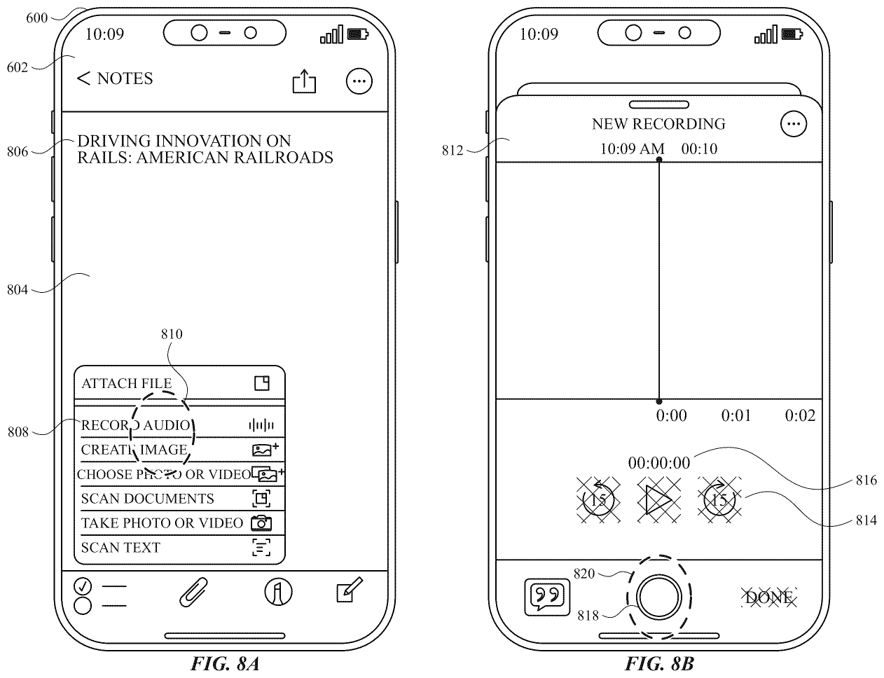

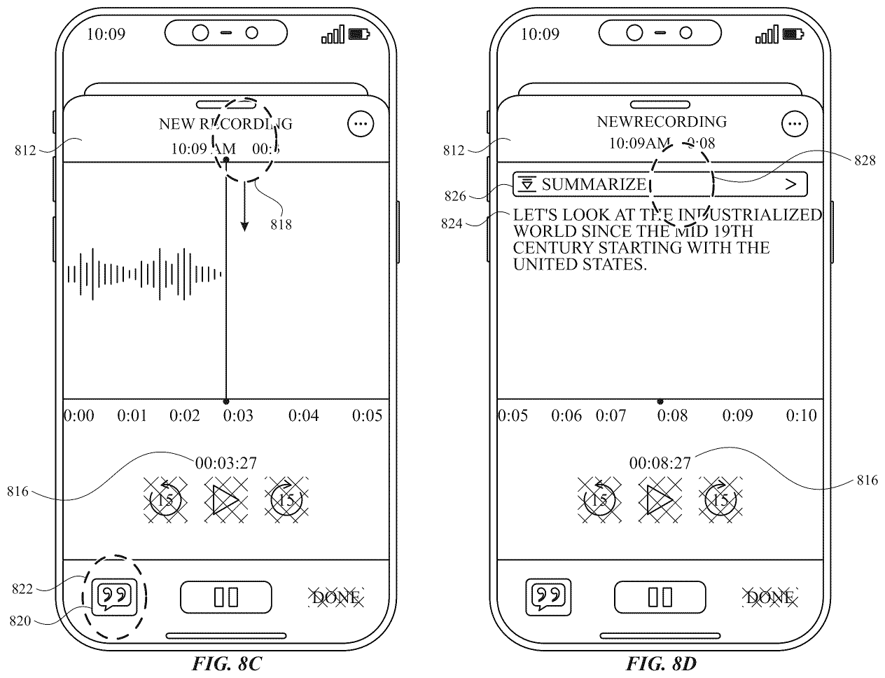

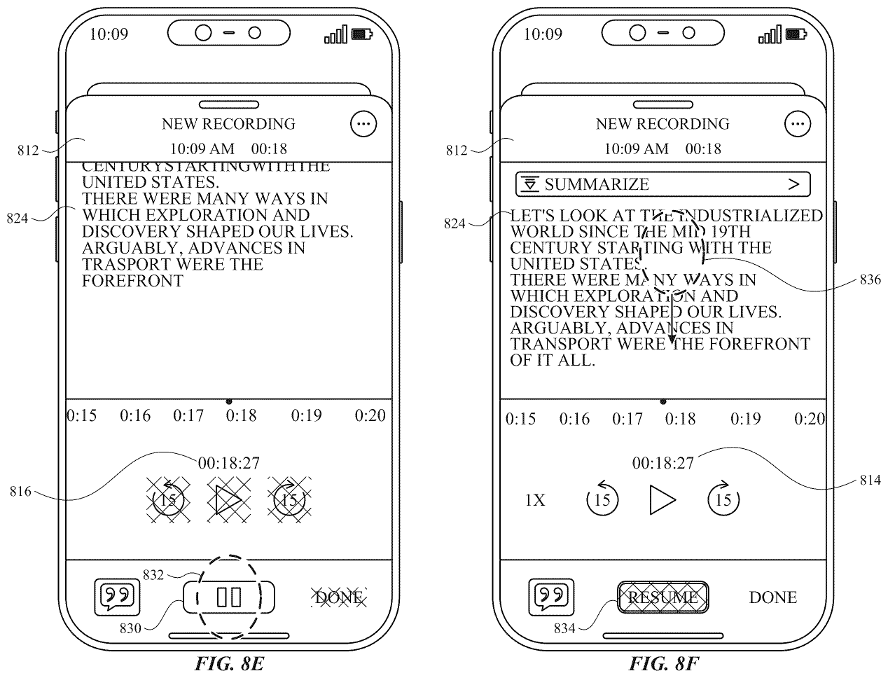

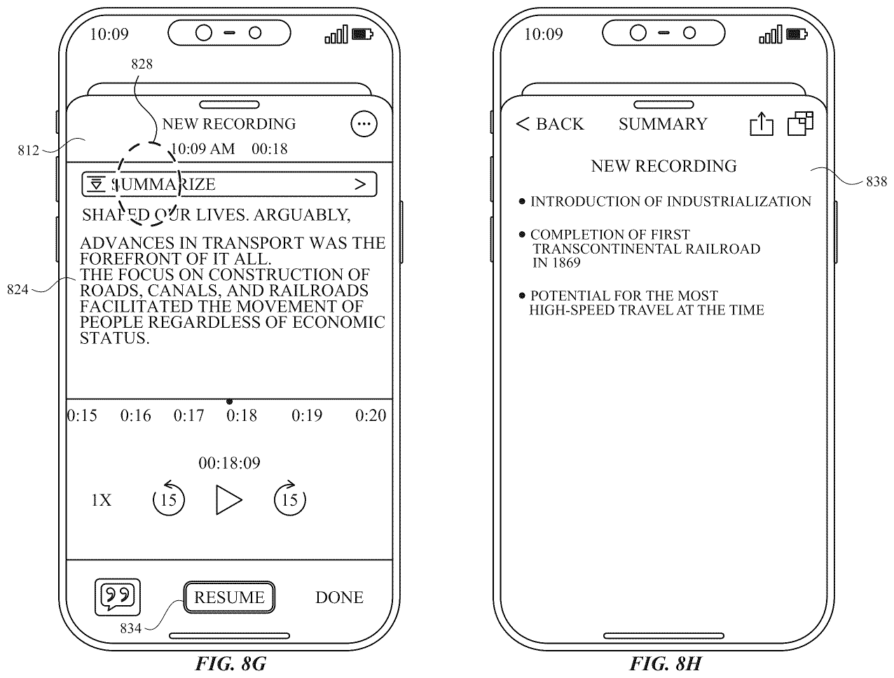

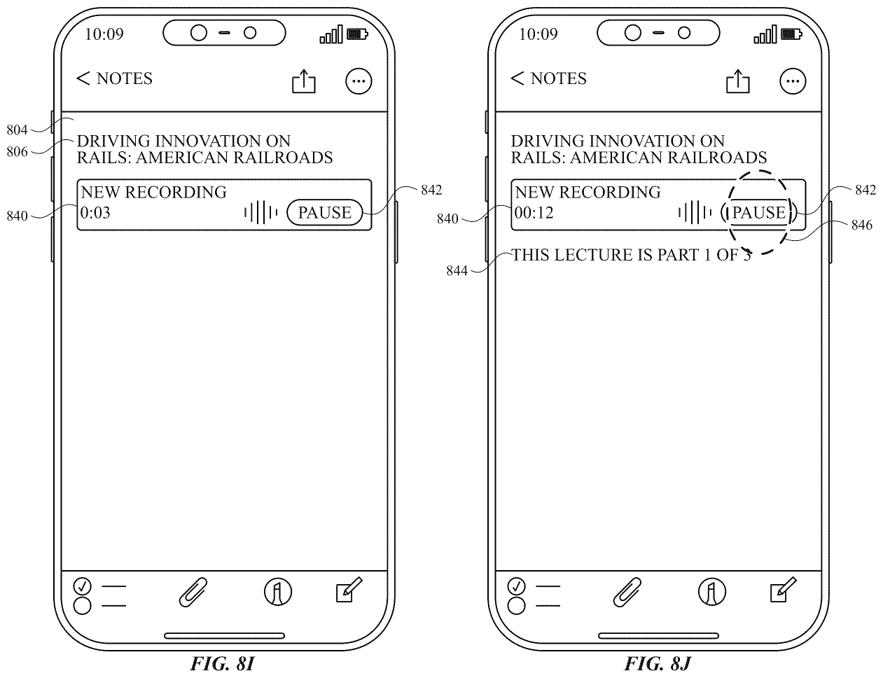

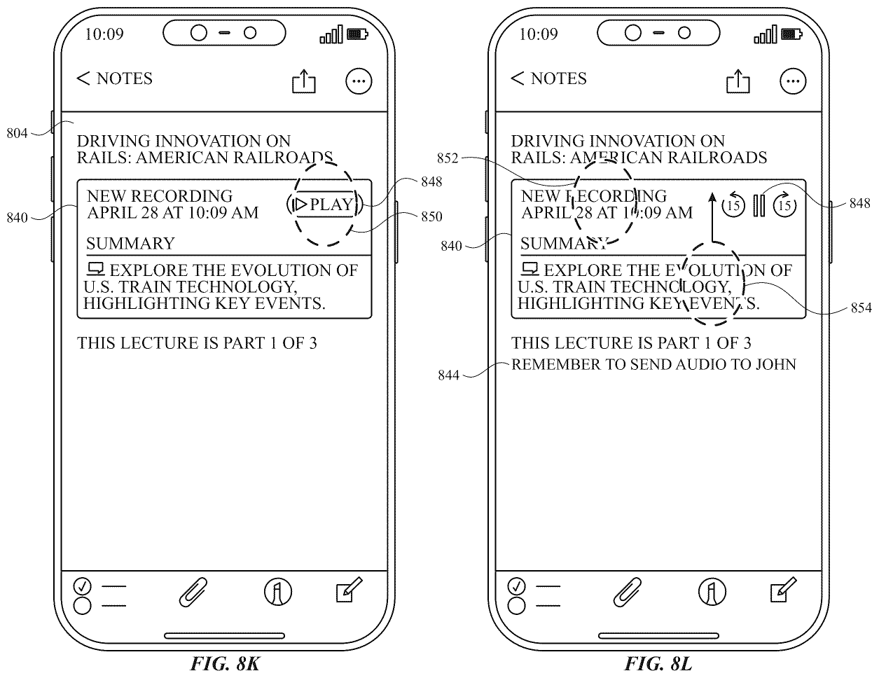

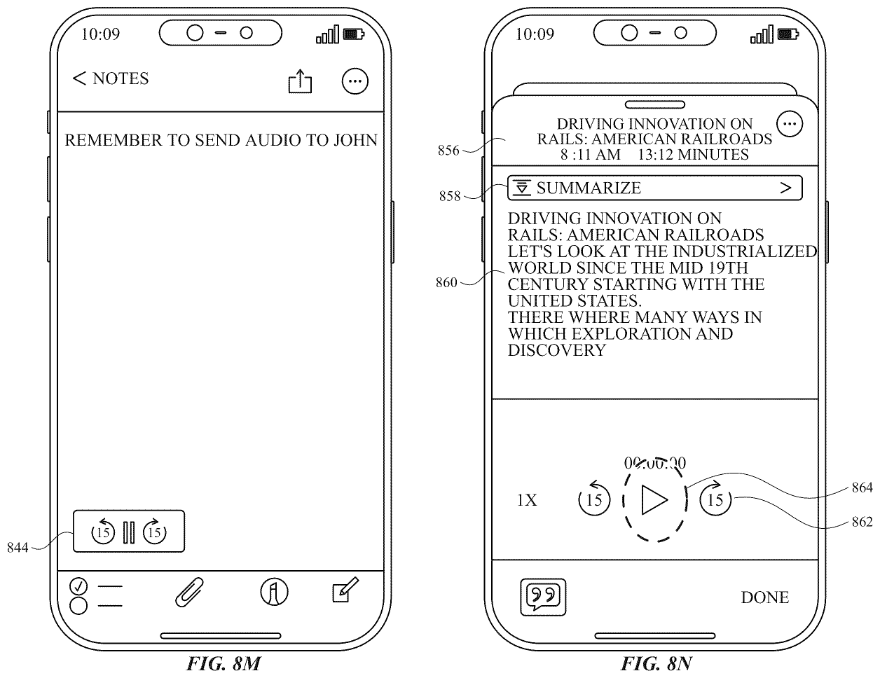

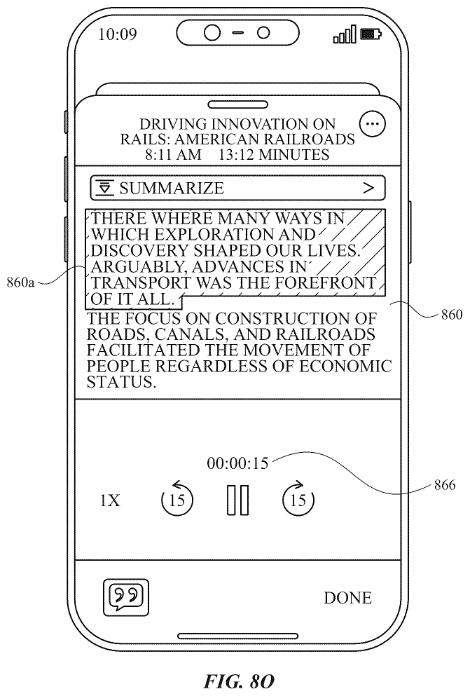

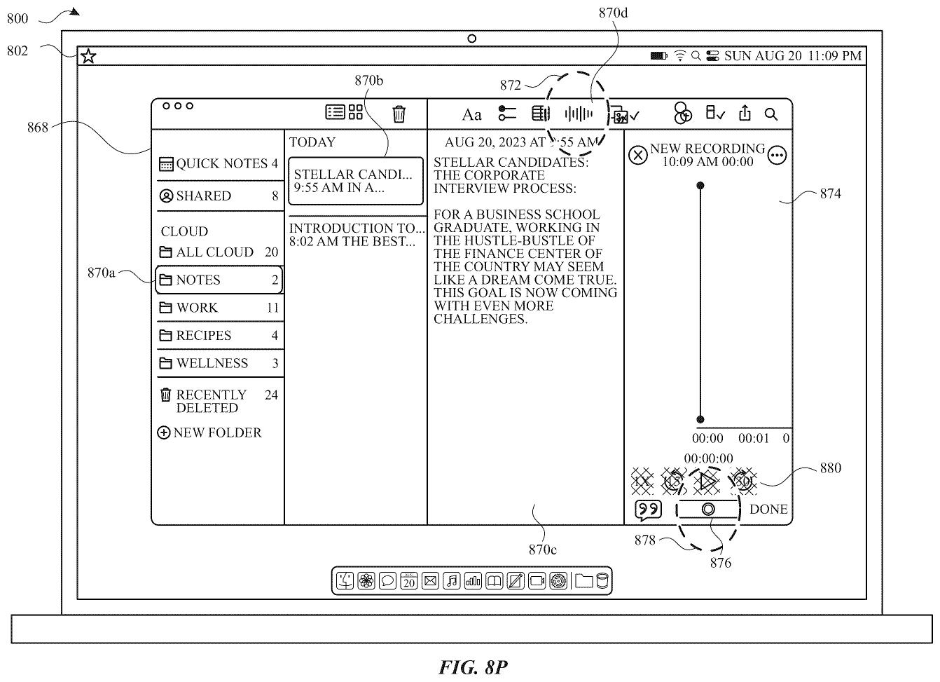

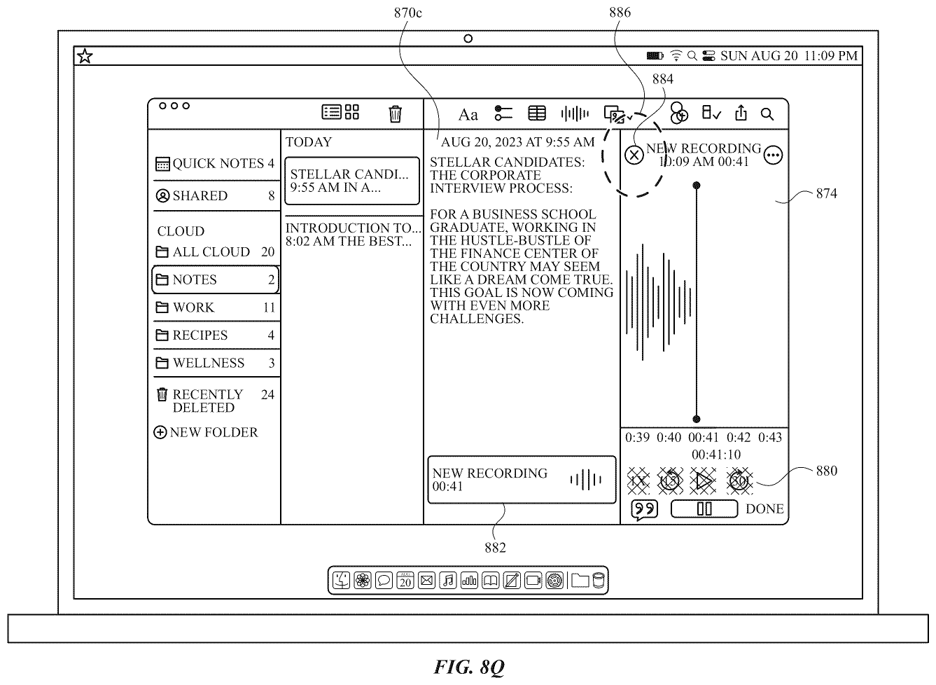

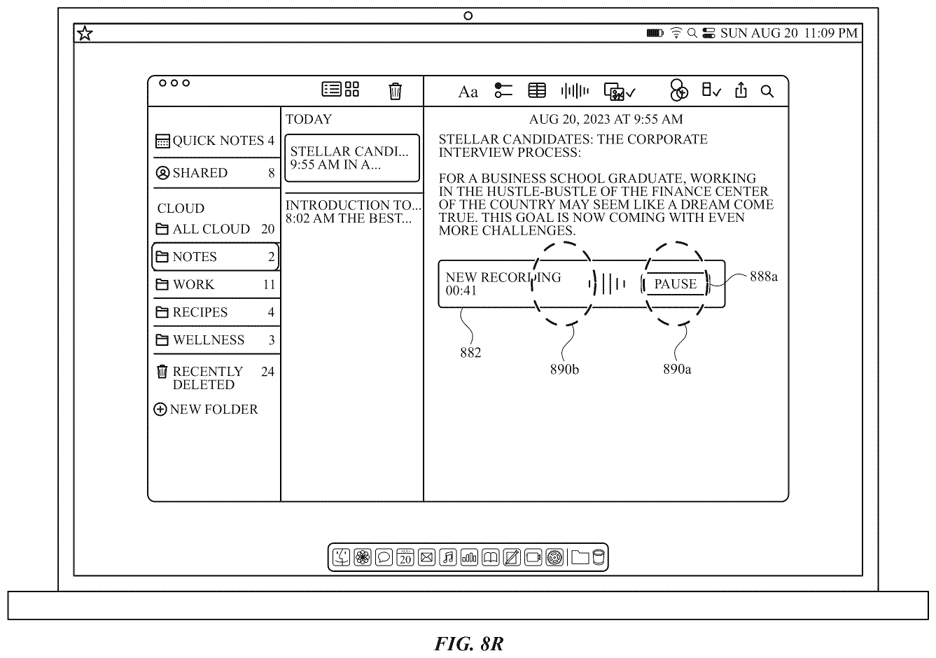

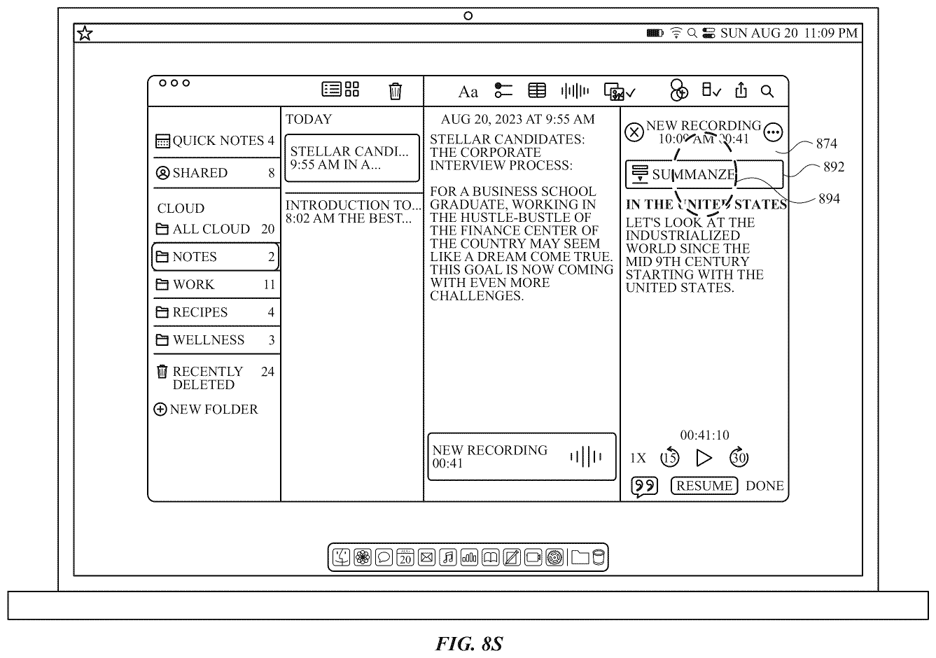

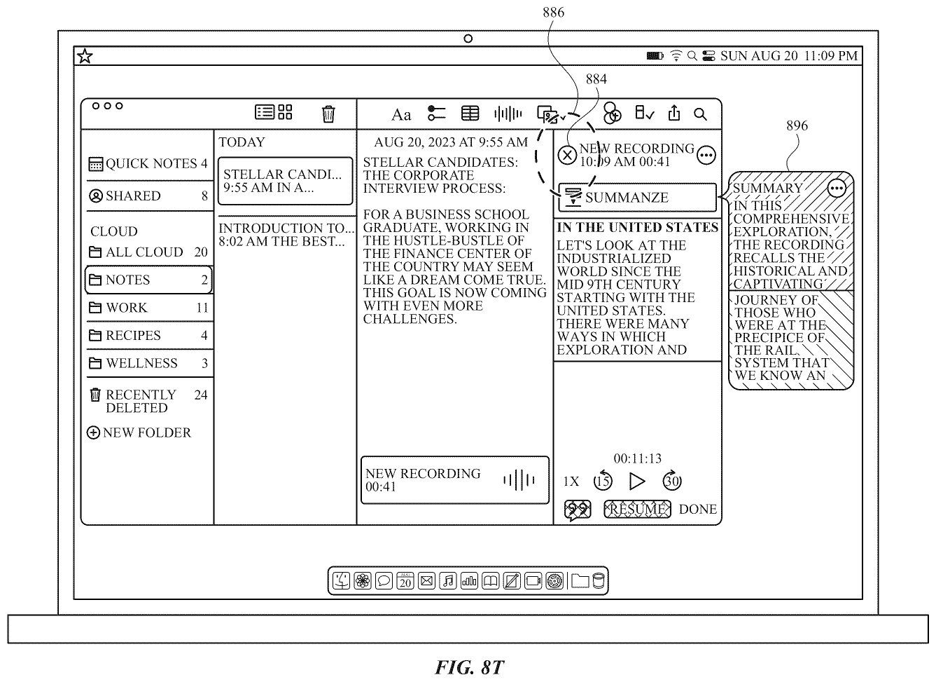

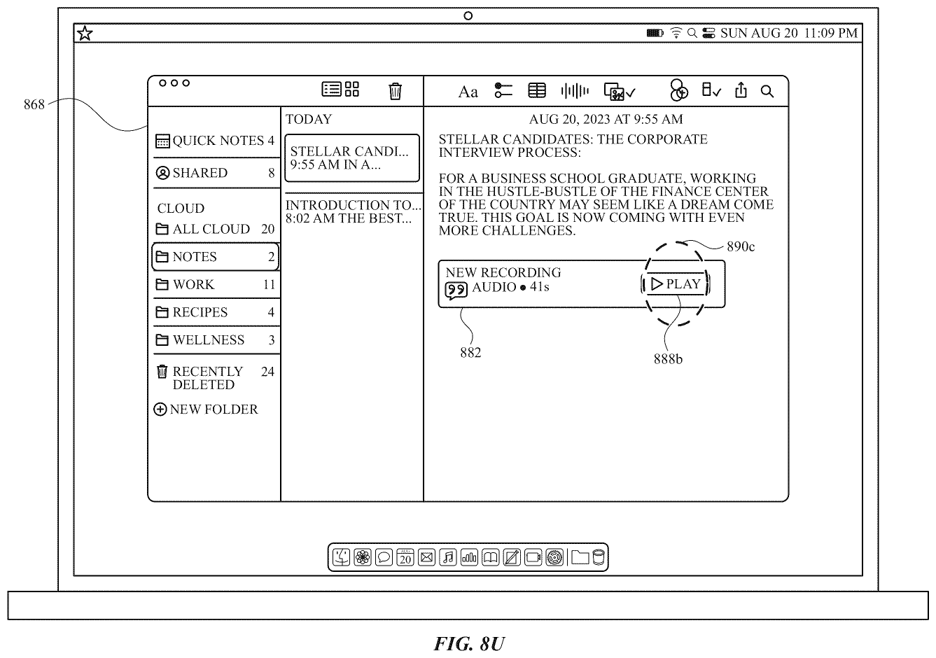

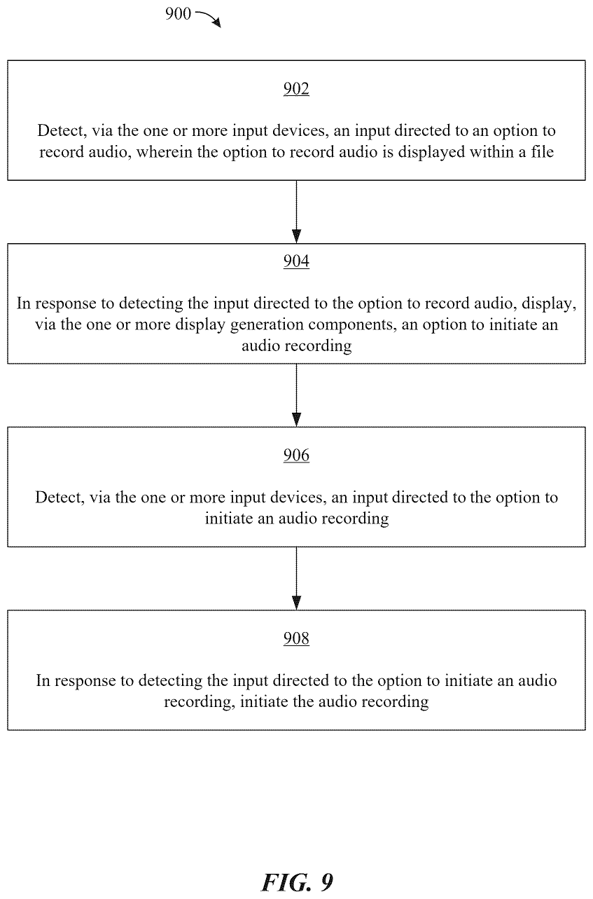

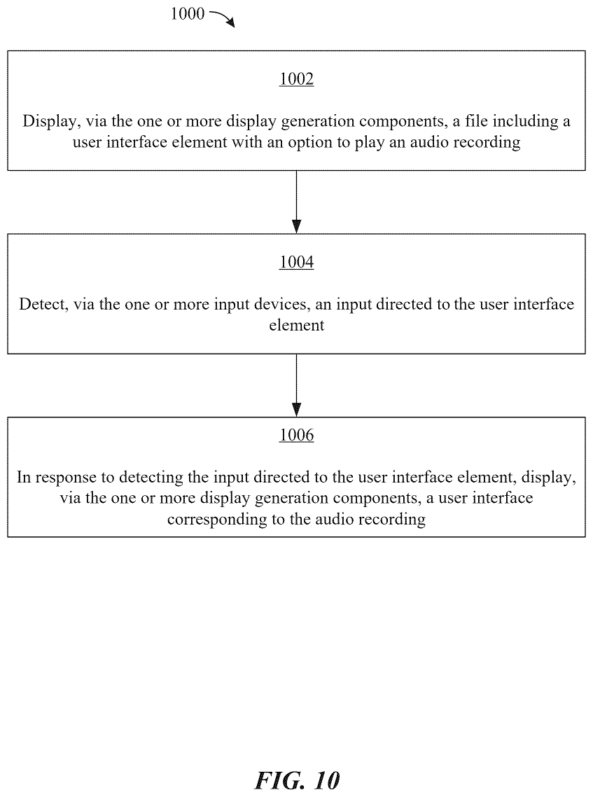

Below, FIGS. 1A-1B, 2, 3A-3G, 4A-4B, and 5A-5B provide a description of exemplary devices for performing the techniques for audio recording and transcription. FIGS. 6A-6U illustrate exemplary user interfaces for audio recording and transcription. FIG. 7 is a flow diagram illustrating methods of audio recording and transcription in accordance with some embodiments. The user interfaces in FIGS. 6A-6U are used to illustrate the processes described below, including the processes in FIG. 7. FIGS. 8A-8U illustrate exemplary user interfaces for audio recording and transcription. FIGS. 9 and 10 are flow diagrams illustrating methods for audio recording and transcription. The user interfaces in FIGS. 8A-8U are used to illustrate the processes described below, including the processes in FIGS. 9 and 10.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

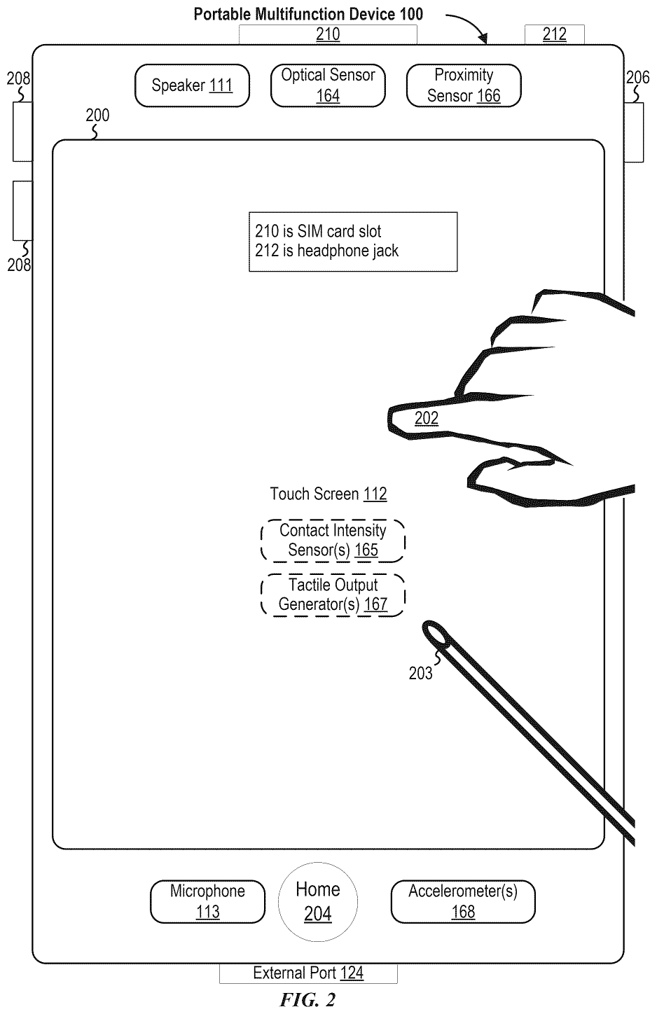

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

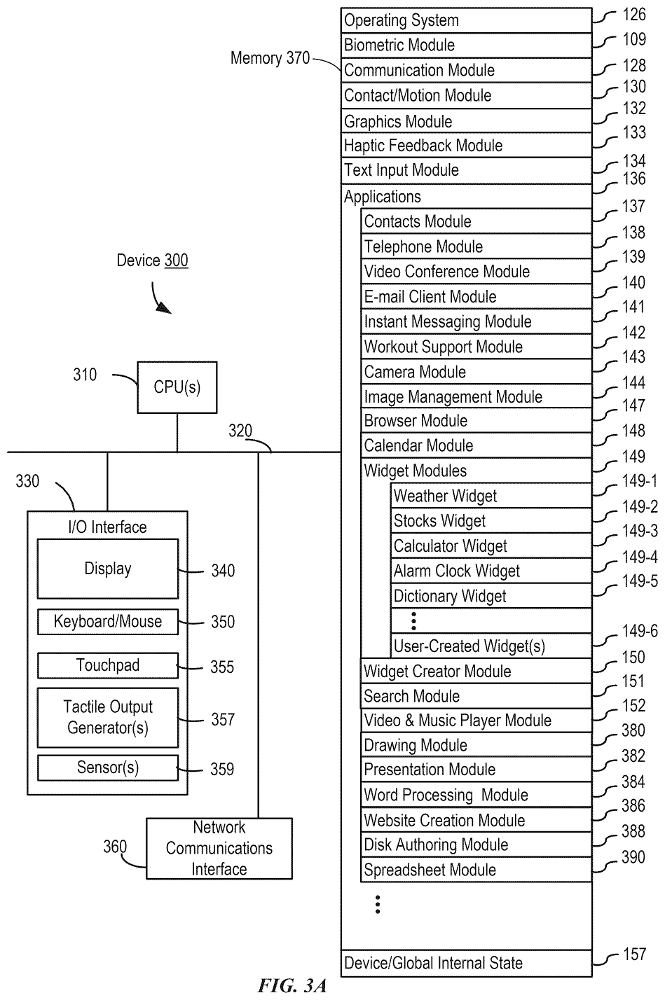

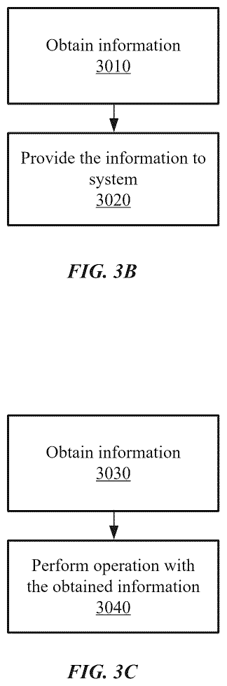

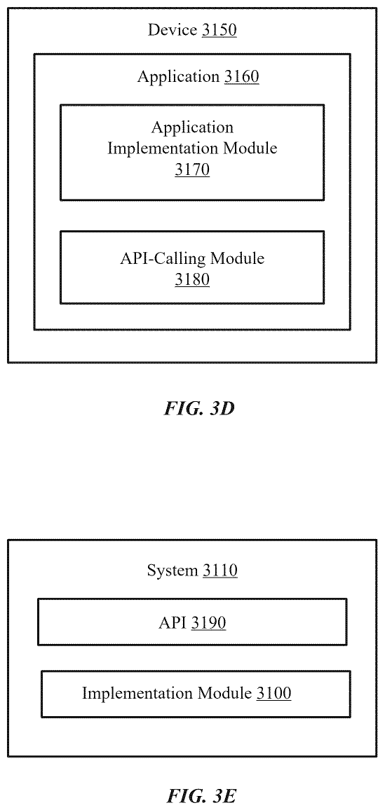

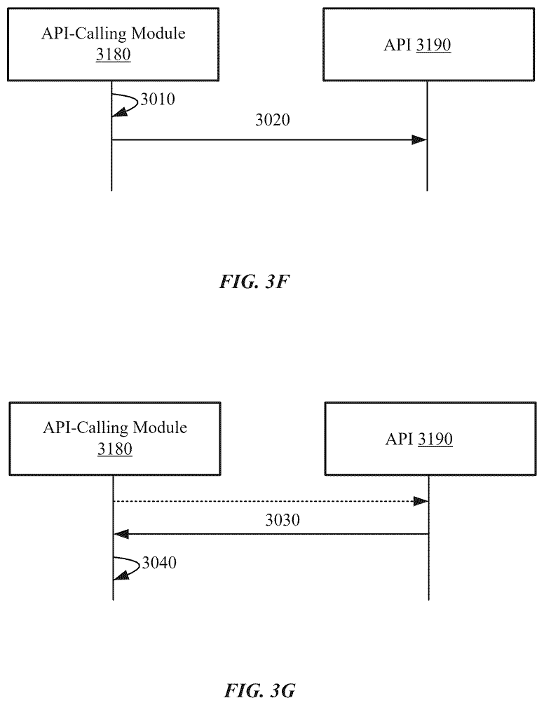

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700, 900, and/or 1000 (FIGS. 7, 9, and/or 10) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

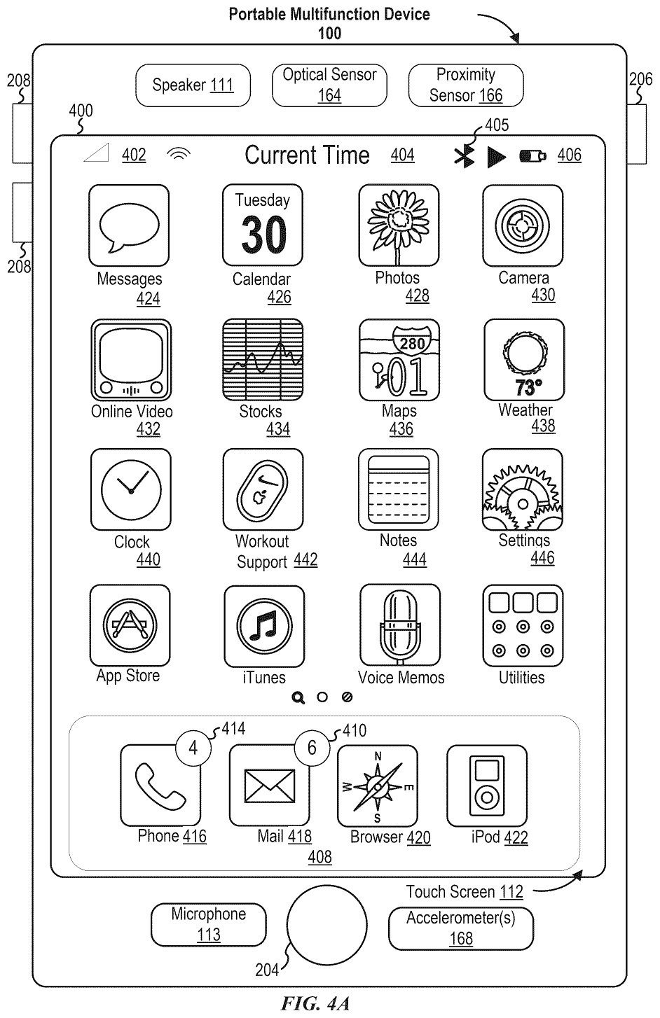

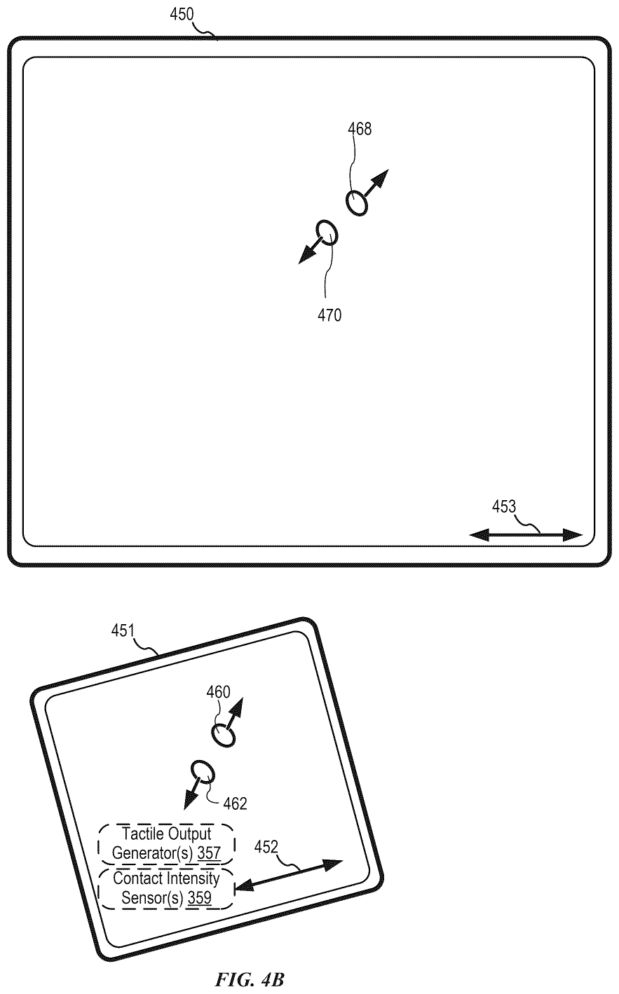

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

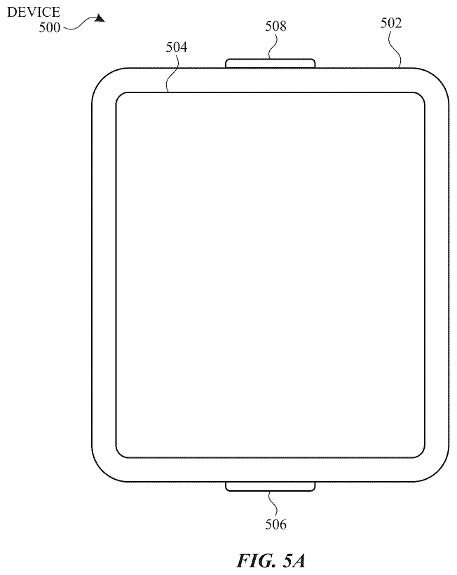

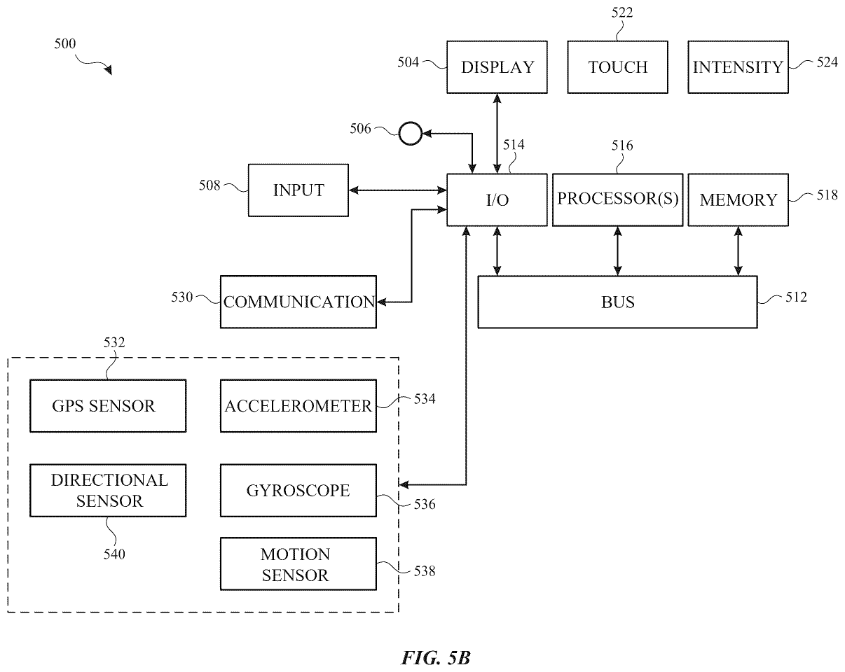

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 900, and 1000 (FIGS. 7, 9, and 10). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Attention is now directed towards embodiments of user interfaces (“UI”) and associated processes that are implemented on an electronic device, such as portable multifunction device 100, device 300, or device 500.

FIGS. 6A-6U illustrate exemplary user interfaces for audio recording and transcription, in accordance with some embodiments. The user interfaces in these figures are used to illustrate the processes described below, including the processes in FIG. 7.

FIGS. 6A-6U illustrate computer system 600. Computer system 600 includes one or more display generation components 602. In FIG. 6A, while computer system 600 is connected to a telephone call, one or more display generation components 602 display telephone call user interface 604. Telephone call user interface 604 includes option 606 for archiving the telephone call. In some embodiments, archiving the telephone call includes creating an audio recording of the telephone call and/or creating a transcription of the telephone call. Computer system 600 detects, via one or more input devices, input 608 directed to option 606 for archiving the telephone call. The telephone call is established between computer system 600 and a second computer system (e.g., to facilitate a conversation between a user of computer system 600 and a second user of the second computer system).

With reference to FIG. 6B, in response to detecting input 608 directed to option 606 for archiving the telephone call, computer system 600 initiates a process for creating an archive based on audio corresponding to the telephone call. In some embodiments, computer system 600 displays prompt 610 in response to detecting input 608 directed to option 606. If the option to archive the telephone call is an option to record audio corresponding to the telephone call, prompt 610 includes an indication that an audio prompt will be played when a predetermined amount of time elapses (e.g., 3 seconds, 4 seconds, or 5 seconds). The audio prompt includes information disclosing to the user of computer system 600 that an audio recording of the telephone call will be created. In some embodiments, in addition to the audio prompt, computer system 600 displays a prompt when a predetermined amount of time elapses indicating that recording of the call will soon commence. The audible prompt and/or the displayed prompt are also provided at the second computer system connected to the telephone call (e.g., the prompt is provided to the second user to inform the second user of the pending recording). In some embodiments, the displayed prompt is provided at the second computer system if the second computer system satisfies criteria (e.g., the second computer system corresponds to a specific device type and/or the second computer system is running a specific operating system).

In some embodiments, in order to ensure the privacy of the users connected to the telephone call, the users are asked and/or prompted to consent to the recording prior to recording beginning. In some embodiments, the users must consent to the recording prior to recording beginning. The displayed and/or audible prompts are thus provided in order to protect the privacy of the parties connected to the telephone call and ensure that the parties have consented to the recording of the telephone call. As a result, the prompts are used in order to prevent non-consensual recording of conversations between users. In addition, a current location of computer system 600 may be subject to local laws and regulations directed to the recording of telephone calls. Accordingly, in order to comply with the laws and regulations, prompts and additional disclosures consistent with the laws and regulations can be provided prior to beginning the recording. For example, additional steps can be performed in order to initiate a recording of the telephone call, such as an explicit approval from all parties (e.g., a prompt requiring a user to accept a request to record the telephone call), providing additional information explaining how the calls will be recorded, and/or providing information as to how the recording will be maintained.

In some embodiments, prompt 610 includes option 612. In some embodiments, in response to detecting an input directed to option 612 (e.g., a tap input and/or a long press input), the pending recording of audio is cancelled. In some embodiments, in response to detecting an input directed to option 612 (e.g., a tap input and/or a long press input), prompt 610 is dismissed, and audio recording commences unless one or more specific inputs are detected, such as the detection of an input directed to option 614 to end the telephone call. Telephone call user interface 604 includes user interface element 604a indicating that computer system 600 is connected to the telephone call. In some embodiments, user interface element 604a includes a specific appearance (e.g., a specific color and/or a specific icon) when computer system is connected to a telephone call, such as a green color with a phone icon.

With reference to FIG. 6C, if computer system 600 does not detect any inputs directed to an option to cancel the pending recording of the telephone call after detecting input 608 on option 606 to begin archiving the telephone call, archiving of the telephone call begins (e.g., an audio recording is created and/or transcription of the telephone call begins). When archiving of the telephone call begins, user interface element 616 is displayed including an audio waveform 618, a current duration of the call archival 620, and option 622 to end call archival. Audio waveform 618 includes a plurality of vertical lines indicating an amplitude of the audio corresponding to the telephone call. In addition, notification 624 is displayed indicating that a note file corresponding to the call archival has been created. In some embodiments, notification 624 is displayed, via one or more display generation components 602, in response to the creation of the note file corresponding to the call archival. In response to input 626 on notification 624, a user interface including the note file is displayed as discussed with respect to FIG. 6E below.

With reference to FIG. 6D, after a predetermined amount of time, notification 624 is removed from display 602. In some embodiments, user interface element 604a changes in appearance once call archival has begun. For instance, prior to call archival beginning, user interface element 604a includes a specific appearance, such as a green color with a phone icon in order to indicate that computer system 600 is connected to a telephone call but call archival is not active. Once call archival begins, user interface element 604a is displayed with an updated appearance, such as a red color with a recording icon in order to indicate that computer system 600 is connected to a telephone call and call archival is active.

With reference to FIG. 6E, in response to input 626 on notification 624, user interface 628 including a note file 630 corresponding to the archival of the telephone call is displayed. Note file 630 includes text 632 indicating the contents of the recording, such as “Call with Emily Kim.” To the extent the call archival is an audio recording corresponding to the telephone call. Note file 630 includes user interface element 634 including an indication that computer system 600 is recording the telephone call and a current duration of the audio recording. User interface 628 also includes user interface element 604a. While note file 630 is displayed, input corresponding to keystrokes (e.g., via a virtual keyboard) causes text to be entered into note file 630 while call recording continues (e.g., as depicted in FIGS. 8I-8J). In response to detecting input 636 on user interface element 604a, computer system 600 displays the telephone call user interface as shown in FIG. 6F.

With respect to FIG. 6F, telephone call user interface 604 is displayed in response to detection of input 636 on user interface element 604a. Telephone call user interface 604 includes user interface element 616 and option 622 to end call archival. In response to detecting input 638 on option 622 to end call archival, call archival ends. For instance, to the extent call archival corresponds to recording audio corresponding to the telephone call, the call recording ceases and a final call recording is saved.

With reference to FIG. 6G, in response to detecting input 638 on option 622 to end call archival, notification 640 is displayed including an indication that an archive (e.g., an audio recording and/or a transcription) has been saved in a notes file. In response to detecting input 642 on notification 640, the note file corresponding to the created recording is displayed as shown in FIG. 6H.

With reference to FIG. 6H, note file 630 corresponding to the archival of the telephone call is displayed. Note file 630 is displayed in response to detecting input 642 on notification 640 and/or is displayed in response to detecting one or more inputs directed to opening a notes application, navigating to a menu corresponding to call recordings, and/or selecting a respective note file corresponding to note file 630. After call archival ends, user interface element 634 includes additional information relative to when call archival is in progress (e.g., as shown in FIG. 6E). User interface element 634 includes information indicating the contact and/or party with which the telephone call was conducted (e.g., “Call with Emily Kim”), a date and/or time corresponding to the telephone call (e.g., a date and/or time corresponding to a beginning of the telephone call, the end of the telephone call, the beginning of the call archival, and/or the end of the call archival), a duration of the recording, and/or a preview of the recording. Displayed concurrently with note file 630 is user interface element 604a indicating that computer system 600 is connected to the telephone call. On the basis that call archival is no longer in progress, user interface element 604a includes an appearance consistent with the telephone call being active but the telephone call not being recorded, such as a green color with a phone icon. If the call archival corresponds to an audio recording of the telephone call, user interface element 634 includes a playback option 644 to initiate playback of the audio recording. In response to input 646 on playback option 644, playback of the audio commences. In some embodiments, in response to input 646 on playback option 644, option 644 changes in appearance to one or more playback controls for rewinding, pausing, and/or fast forwarding the audio playback (e.g., similar to and/or the same as depicted in FIG. 8L). In some embodiments, an input 648 on user interface element 634 is detected (e.g., an input directed to an area of user interface element 634 that does not correspond to playback option 644). In response to detection of input 648, an archive details interface is displayed as shown in FIG. 6I.

With reference to FIG. 6I, archive details interface 650 is displayed in response to detection of input 648. Archive details interface 650 includes information indicating the contact and/or party with which the telephone call was conducted (e.g., “Call with Emily Kim”), a date and/or time corresponding to the telephone call (e.g., a date and/or time corresponding to a beginning of the telephone call, the end of the telephone call, the beginning of the call archival, and/or the end of the call archival), and a duration of the recording. In addition, archive details interface 650 includes summary 652 corresponding to the archived telephone call. In some embodiments, summary 652 is different from the preview displayed within user interface element 634 (e.g., as shown in FIG. 6H). For instance, summary 652 is longer in length (e.g., more characters and/or words) than the preview. Archive details interface 650 includes a transcription 654 of the archived call, playback controls 656 (e.g., a playback speed control, a rewind control, a play control, a pause control, and a fast forward control), and a current playback position 658. In some embodiments, in response to a detected gesture within archive details interface 650 (e.g., a swipe and/or scroll gesture), archive details interface 650 is updated to display additional content within the transcription (e.g., scrolling further up and/or down within the transcription).

With reference to FIG. 6O, a recent call interface 660 is displayed. Recent call interface 660 includes a plurality of recent call entries, such as recent call entry 662a, recent call entry 662b, and recent call entry 662c. If a call corresponding to a call entry is associated with a previously created archive, recent call interface 660 includes details regarding the call archive. For instance, archive indication 664 is displayed under call entry 662a to indicate that the call corresponding to call entry 662a has a corresponding archive. Archive indication 664 includes a portion of a transcription associated with the archive and a duration of the recording and/or a duration of the call.

With reference to FIG. 6K, an alternate orientation of computer system 600 is shown while computer system 600 is connected to a telephone call. Computer system 600 is shown in a landscape orientation, such that telephone call user interface 668 is displayed in a landscape orientation. In some embodiments, while telephone call user interface 668 is displayed in a landscape orientation, an option for archiving the telephone call (e.g., option 606 depicted in FIG. 6A) is not displayed. If the user rotates computer system 600, telephone call user interface 668 is displayed in a portrait orientation with an option for archiving the telephone call (e.g., as depicted in FIG. 6A). Alternatively, in some embodiments, while telephone call user interface 668 is displayed in a landscape orientation, an option for archiving the telephone call is displayed.

With reference to FIG. 6L, the user may have previously initiated archival of the telephone call. In some embodiments, while telephone call user interface 668 is displayed in a landscape orientation, option 670 for ending the archival of the telephone call is displayed. In response to detecting an input directed to option 670, archival of the telephone call is ended.

With reference to FIG. 6M, while computer system 600 is connected to a telephone call, telephone call user interface 672 is displayed. Telephone call user interface 672 includes option 674 for archiving the telephone call. In some embodiments, option 674 corresponds to an option to transcribe the telephone call without recording and/or savings an audio recording of the telephone call. Computer system 600 detects input 676 directed to option 674 for transcribing the telephone call. The telephone call is established between computer system 600 and a second computer system (e.g., to facilitate a conversation between a user of computer system 600 and a second user of a second computer system).

With reference to FIG. 6N, in response to detecting input 676 directed to option 674 for transcribing the telephone call, computer system 600 initiates a process for transcribing the telephone call. In some embodiments, computer system 600 displays prompt 678 in response to detecting input 676 directed to option 674. Prompt 678 includes an indication that an audio prompt will be played within a predetermined amount of time (e.g., 3 seconds, 4 seconds, or 5 seconds). The audio prompt includes information disclosing to the user of computer system 600 that a transcription of the telephone call will be created. In some embodiments, in addition to the audio prompt, computer system 600 displays a prompt when a predetermined amount of time elapses indicating that transcription of the call will soon commence. The audible prompt and/or the displayed prompt are also provided at the second computer system connected to the telephone call (e.g., the prompt is provided to the second user to inform the second user of the pending transcription). In some embodiments, the displayed prompt is provided at the second computer system if the second computer system satisfies criteria (e.g., the second computer system corresponds to a specific device type and/or the second computer system is running a specific operating system).

In some embodiments, in order to ensure the privacy of the users connected to the telephone call, the users are asked and/or prompted to consent to the transcription prior to transcription beginning. In some embodiments, the users must consent to the transcription prior to transcription beginning. The displayed and/or audible prompts are thus provided in order to protect the privacy of the parties connected to the telephone call and ensure that the parties have consented to the transcription of the telephone call. As a result, the prompts are used in order to prevent non-consensual transcription of conversations between users. In addition, a current location of computer system 600 may be subject to local laws and regulations directed to the transcription of telephone calls. Accordingly, in order to comply with the laws and regulations, prompts and additional disclosures consistent with the laws and regulations can be provided prior to beginning the transcription. For example, additional steps can be performed in order to initiate a transcription of the telephone call, such as an explicit approval from all parties (e.g., a prompt requiring a user to accept a request to transcribe the telephone call), providing additional information explaining how the calls will be transcribed, and/or providing information as to how the transcription will be maintained.

In some embodiments, prompt 678 includes option 680. In some embodiments, in response to detecting an input directed to option 680 (e.g., a tap input and/or a long press input), the pending transcription of audio is cancelled. In some embodiments, in response to detecting an input directed to option 680 (e.g., a tap input and/or a long press input), prompt 678 is dismissed, and the transcription will commence unless one or more specific inputs are detected, such as the detection of an input directed to option 682 to end the telephone call. Telephone call user interface 672 includes user interface element 672a indicating that computer system 600 is connected to the telephone call. In some embodiments, user interface element 672a includes a specific appearance (e.g., a specific color and/or a specific icon) when computer system is connected to a telephone call, such as a green color with a phone icon.

With reference to FIG. 6O, if computer system 600 does not detect any inputs directed to an option to cancel the pending transcription of the telephone call after detecting input 676 on option 674 to begin transcribing the telephone call, transcription of the telephone call begins. When transcription of the telephone call begins, user interface element 684 is displayed including an ongoing transcription of the telephone call. User interface elements 684 displays one or more lines of the transcription (e.g., 2 lines, 3 lines, or 4 lines). User interface element 684 includes option 686 to end call transcription. In addition, notification 624 is displayed indicating that a note file corresponding to the call archival has been created. In some embodiments, notification 688 is displayed in response to the creation of a note file corresponding to the call transcription. In response to input 690 on notification 688, a user interface including the note file is displayed as discussed with respect to FIG. 6Q below.

With reference to FIG. 6P, after a predetermined amount of time, notification 690 is removed from display 602. In some embodiments, user interface element 672a changes in appearance once call transcription has begun. For instance, prior to call archival beginning, user interface element 672a includes a specific appearance, such as a green color with a phone icon in order to indicate that computer system 600 is connected to a telephone call but call transcription is not active. Once call transcription begins, user interface element 672a is displayed with an updated appearance, such as including a red color with a transcription icon in order to indicate that computer system 600 is connected to a telephone call and call transcription is active.

With reference to FIG. 6Q, in response to input 690 on notification 688, user interface 692 including note file 694 corresponding to the transcription of the telephone call is displayed. Note file 694 includes text 696 indicating the contents of the recording, such as “Call with Emily Kim.” Note file 694 includes user interface element 698 including an indication that computer system 600 is transcribing the telephone call. In some embodiments, note file 694 includes a transcription 601. In some embodiments, note file 694 does not include transcription 601, such that transcription 601 is provided within note file 694 once transcription has finished (e.g., an input is detected to end transcription and/or the call ends). Transcription 601 includes a creation date (e.g., a timestamp corresponding to the initiation of transcription). Transcription 601 includes text representing speech from each user within the telephone call, and indicates the name (e.g., if known) of the user who uttered the speech. User interface 694 also includes user interface element 672a. In response to detecting input 601 on user interface element 672a, computer system 600 displays the telephone call user interface as shown in FIG. 6R.

With reference to FIG. 6R, telephone call user interface 672 is displayed in response to computer system 600 detecting input 601 on user interface element 672a. In some embodiments, input 603 directed to option 686 to end call transcription, which is displayed within user interface element 684. In response to detecting input 603 on option 686 to end call transcription, call transcription ends and final call transcription is saved.

With reference to FIG. 6S, in response to detecting input 603 on option 868 to end call transcription, notification 605 is displayed including an indication that a transcription has been saved in a notes file. In response to detecting input 607 on notification 605, the note file corresponding to the created recording is displayed as shown in FIG. 6T.

With reference to FIG. 6T, in response to detecting input 607 on notification 605, user interface 692 including note file 694 corresponding to the transcription of the telephone call is displayed. Note file 694 is also displayed in response to detecting one or more inputs directed to opening a notes application, navigating to a menu corresponding to call transcriptions, and/or selecting a respective note file corresponding to note file 694. After call transcription ends, user interface element 698 includes additional information relative to when call transcription is in progress (e.g., as shown in FIG. 6Q). User interface element 698 includes information indicating the contact and/or party with which the telephone call was conducted (e.g., “Call with Emily Kim”), a date and/or time corresponding to the telephone call (e.g., a date and/or time corresponding to a beginning of the telephone call, the end of the telephone call, the beginning of the call transcription, and/or the end of the call transcription), a duration of the call, and/or a preview of the transcription. Displayed concurrently with note file 694 is user interface element 678a indicating that computer system 600 is connected to the telephone call (e.g., the transcription was ended but the call is still in progress). If call transcription is no longer in progress, user interface element 678a includes an appearance consistent with the telephone call being active but the telephone call not being transcribed, such as a green color with a phone icon. While note file 694 is displayed, input corresponding to keystrokes (e.g., via a virtual keyboard) causes text to be entered into note file 694 while call recording continues (e.g., as depicted in FIGS. 8I-8J). In some embodiments, an input 609 on user interface element 698 is detected. In response to detection of input 609, a transcription details interface is displayed as shown in FIG. 6U.

With reference to FIG. 6U, transcription details interface 611 is displayed in response to detection of input 609. Transcription details interface 611 includes information indicating the contact and/or party with which the telephone call was conducted (e.g., “Call with Emily Kim”), a date and/or time corresponding to the telephone call (e.g., a date and/or time corresponding to a beginning of the telephone call, the end of the telephone call, the beginning of the call transcription, and/or the end of the call transcription), and a duration of the recording. In addition, transcription details interface 611 includes summary 613 corresponding to the transcription. In some embodiments, summary 613 is different from the preview displayed within user interface element 698 (e.g., as shown in FIG. 6T). For instance, summary 613 is longer in length (e.g., more characters and/or words) than the preview. Transcription details interface 611 further includes a transcription 615 of the archived call. In some embodiments, in response to a detected gesture within transcription details interface 611 (e.g., a swipe and/or scroll gesture), transcription details interface 611 is updated to display additional content within transcription 615 (e.g., scrolling further up and/or down within the transcription).

FIG. 7 is a flow diagram illustrating a method for audio recording and transcription using a computer system in accordance with some embodiments. Method 700 is performed at a computer system (e.g., 100, 300, 500, 600, and/or 800) that is in communication one or more display generation components (e.g., 602, 802, a display controller, a display, a touch-sensitive display system, a touchscreen, a monitor, and/or a head mounted display system) and one or more input devices (e.g., a touch-sensitive surface, a physical button, a rotatable input mechanism, a rotatable and depressible input mechanism, a motion sensor, an accelerometer, a gyroscope, a keyboard, a controller, and/or a mouse). Some operations in method 700 are, optionally, combined, the orders of some operations are, optionally, changed, and some operations are, optionally, omitted.

As described below, method 700 provides an intuitive way for facilitating audio recording and transcription. The method reduces the cognitive burden on a user when using recording and transcribing audio, thereby creating a more efficient human-machine interface. For battery-operated computing devices, enabling a user to record and transcribe audio faster and more efficiently conserves power and increases the time between battery charges.

While the computer system (e.g., 600) is connected to a telephone call (e.g., a telephone call with one other party or a telephone call with multiple parties), the computer system displays (702), via the one or more display generation components (e.g., 602), a telephone call user interface (e.g., 604, 672, an interface including a speaker button, a video call button, a mute button, an add participant button, and end call button, and/or a keypad button).

While displaying the telephone call user interface (e.g., 604 and/or 672), in accordance with (or, in some embodiments, in response to) a determination that archival option criteria are met (e.g., the telephone call is with one other party and/or the telephone call is with a remote device of a specific type), the computer system (e.g., 600) displays (704) (e.g., in the telephone call user interface), via the one or more display generation components (e.g., 602), an option (e.g., 606, 674, a selectable user interface element, an icon, a button, an affordance, a selectable option, and/or a user-interactive user interface element) for archiving the telephone call (e.g., the computer system displays a button in an upper left corner of the telephone call user interface or a button in an upper right corner of the telephone call user interface).

The computer system (e.g., 600) detects (706) (e.g., while displaying the telephone call user interface), via the one or more input devices, an input (e.g., 608 and/or 676) (e.g., tap input and/or other selection input) directed to (e.g., on or at) the option for archiving the telephone call (e.g., 606 and/or 674).

In response to detecting the input (e.g., 608 and/or 676) directed to the option for archiving the telephone call (e.g., 606 and/or 674), the computer system (e.g., 600) initiates (708) a process for creating an archive (e.g., a transcription and/or an audio recording) based on audio corresponding to the telephone call (e.g., the computer system creates a file that includes a recording and/or a transcription of the telephone call or updates a file to include a recording and/or transcription of the telephone call). In some embodiments, the computer system creates an archive (e.g., a recording and/or transcription) of the telephone call in response to detecting the input directed to the option for archiving the telephone call. Displaying a telephone call user interface with an option for archiving a telephone call if archival option criteria are met, and in response to detecting an input directed to the option for archiving the telephone call, creating an archive based on audio corresponding to the telephone call reduces the number of inputs required to perform an operation and improves visual feedback to the user.

In some embodiments, in response to detecting the input (e.g., 608 and/or 676) directed to the option for archiving the telephone call (e.g., 606 and/or 674), the computer system (e.g., 600) provides a prompt (e.g., 610 and/or 678) (e.g., audible and/or displayed) indicating that the archive will be created when an amount of time elapses (e.g., 3 seconds, 4 seconds, and/or 5 seconds). In some embodiments, the prompt is provided when the recording and/or transcription is created. In some embodiments, prior to providing the prompt indicating that the archive will be created when an amount of time elapses, a second prompt is displayed at the computer system indicating that the prompt will be provided. Providing a prompt indicating than an archive will be created when an amount of time elapses in response to detecting an input directed to an option for archiving a telephone call improves visual feedback to the user and performs an operation when a set of conditions has been met without requiring further user input.

In some embodiments, the computer system (e.g., 600) is connected to the telephone call with a second computer system. In some embodiments, the computer system causes a second prompt (e.g., audible and/or displayed) to be provided at the second computer system, wherein the second prompt indicates that the archive will be created when an amount of time elapses (e.g., 3 seconds, 4 seconds, and/or 5 seconds). In some embodiments, the prompt is provided when the recording and/or transcription is created. Causing a second prompt to be provided at a second computer system indicating that an archive will be created when an amount of time elapses improves visual feedback to the user and performs an operation when a set of conditions has been met without requiring further user input.

In some embodiments, the computer system (e.g., 600) provides the prompt indicating that the archive will be created when an amount of time elapses includes providing (e.g., displaying) a user interface element (e.g., 612, a button, and/or an option). In some embodiments, at a time corresponding to when the amount of time elapses (e.g., 3 seconds after the prompt is provided, 4 seconds after the prompt is provided, and/or 5 seconds after the prompt is provided), in accordance with a determination that an input directed to the user interface element has not been detected (e.g., via the one or more input devices), the computer system creates the archive based on audio corresponding to the telephone call. Creating an archive based on audio corresponding to a telephone call at a time corresponding to when the amount of time elapses if an input directed to the user interface element has not been detected improves visual feedback to the user and performs an operation when a set of conditions has been met without requiring further user input.

While the telephone call is being archived, providing a periodic prompt (e.g., audible and/or displayed; e.g., every 5 minutes, every 10 minutes, and/or every 15 minutes) indicating that archival of the telephone call is in progress. In some embodiments, the computer system (e.g., 600) causes a second periodic prompt to be provided at a second computer system connected to the telephone call. Providing a periodic prompt indicating that archival of the telephone call is in progress in response to creating the archive based on audio corresponding to the telephone call provides improved feedback to the user.

While the computer system (e.g., 600) is connected to the telephone call, the computer system displays, via the display generation component, a user interface element indicating that the computer system is connected to the telephone call (e.g., 604a, 678a, a user interface element including an icon, an audio waveform, and/or a call duration). In some embodiments, while the computer system is not connected to the telephone call, the user interface element is not displayed. In some embodiments, the user interface element is temporarily not displayed when being covered by a displayed notification and/or banner. In some embodiments, in accordance with a determination that archival of the telephone call is in progress, the computer system displays the user interface element in a first state (e.g., displaying the icon, the audio waveform, and/or the call duration in a red color). In some embodiments, in accordance with a determination that archival of the telephone call is not in progress, the computer system displays the user interface element in a second state that is different from the first state (e.g., displaying the icon, the audio waveform, and/or the call duration in a green color). Displaying the user interface element in different states in accordance with a determination whether archival of the telephone call is in progress provides improved visual feedback to the user.

In response to creating the archive based on audio corresponding to the telephone call (e.g., in response to creating a file including the recording and/or transcription or in response to updating a notice file to include the recording and/or transcription), the computer system (e.g., 600) displays, via the one or more display generation components (e.g., 602), a notification (e.g., 624 and/or 688) indicating that a file (e.g., user-editable data, an electronic note, and/or information stored on the computer system) corresponding to the archive has been created. In some embodiments, the notification includes a name and/or phone number of a second computer system connected to the telephone call. In some embodiments, the file includes text, photos, videos, and/or links (e.g., hyperlinks) to additional content accessible at the computer system and/or a remote system (e.g., via the internet). In some embodiments, the file is created, modified, updated, and or deleted by a user of the computer system. In some embodiments, the file is accessible via one or more applications on the computer system. In some embodiments, the file is sharable with one or more additional computer systems. Displaying a notification indicating that a file corresponding to the archive has been created provides improved visual feedback to the user.

The computer system (e.g., 600) detects, via the one or more input devices, an input (e.g., 642, 690, a tap input and/or a long press input) directed to (e.g., on or at) the notification indicating that the file corresponding to the archive has been created. In response to detecting the input directed to the notification, the computer system displays, via the one or more display generation components (e.g., 602), the file corresponding to the archive (e.g., displaying a notes application overlaid on the telephone call user interface and/or replacing display of the telephone call user interface with the notes application). Displaying a file corresponding to the archive in response to detecting input directed to the notification provides improved visual feedback to the user and provides additional control options without cluttering the user interface with additional displayed controls.

In some embodiments, archiving the telephone call includes recording audio corresponding to the telephone call and the archive includes an audio recording of the telephone call. In some embodiments, while the audio recording is being created, the computer system displays, via the one or more display generation components (e.g., 602), a file (e.g., 630, 694, user-editable data, an electronic note, and/or information stored on the computer system) corresponding to the audio recording, wherein the file includes a user interface element that indicates a pending duration of the audio recording. In some embodiments, the file includes a name and/or a phone number of a second computer system connected to the telephone call. In some embodiments, the notification includes a name and/or phone number of a second computer system connected to the telephone call. In some embodiments, the file includes text, photos, videos, and/or links (e.g., hyperlinks) to additional content accessible at the computer system (e.g., 600) and/or a remote system (e.g., via the internet). In some embodiments, the file is created, modified, updated, and or deleted by a user of the computer system. In some embodiments, the file is accessible via one or more applications on the computer system. In some embodiments, the file is sharable with one or more additional computer systems. Displaying a file including a user interface element indicating a pending duration of an audio recording provides improved visual feedback to the user and reduces the number of inputs needed to perform an operation.

In some embodiments, the determination that the archival option criteria are met includes a determination that the computer system (e.g., 600) is positioned in a first orientation (e.g., a portrait orientation and/or an orientation within a degree of correspondence to a portrait orientation). In accordance with a determination that the archival option criteria are not met based on the computer system being positioned in the first orientation, the computer system forgoes displaying, via the one or more display generation components (e.g., 602), the option for archiving the telephone call (e.g., 606 and/or 674) (e.g., the computer system displays the telephone call user interface without the archive user interface element). In some embodiments, in accordance with a determination that the computer system is positioned in a second orientation (e.g., a landscape orientation and/or an orientation within a degree of correspondence to a landscape orientation) different from the first orientation and a determination that recording and/or transcribing of the telephone call is not in progress, the computer system displays, via the one or more display generation components (e.g., 602), the option for recording and/or transcribing the telephone call. Displaying or forgoing displaying the option for archiving the telephone call based on an orientation of the computer system improved visual feedback to the user and provides additional control options without cluttering the user interface with additional displayed controls.

In some embodiments, the archival option criteria include a criterion that is met when the computer system (e.g., 600) is positioned in the first orientation (e.g., a portrait orientation and/or an orientation within a degree of correspondence to a portrait orientation). Displaying or forgoing displaying the option for archiving the telephone call based on an orientation of the computer system improved visual feedback to the user and provides additional control options without cluttering the user interface with additional displayed controls.

In accordance with a determination that the archival based on audio corresponding to the telephone call has been initiated and a determination that the computer system (e.g., 600) is positioned in a second orientation that is different from the first orientation (e.g., a landscape orientation and/or an orientation within a degree of correspondence to a landscape orientation), the computer system displays, via the one or more display generation components (e.g., 602), an option (e.g., 670, a selectable user interface element, an icon, a button, an affordance, a selectable option, and/or a user-interactive user interface element) to end archival of the telephone call. In some embodiments, the computer system detects, via the one or more input devices, a user input directed to the option to end archival of the telephone call. In some embodiments, in response to detecting a user input directed to the option to end archival of the telephone call, the computer system stops creating the archive. Displaying the option to end archival of the telephone call based on an orientation of the computer system improved visual feedback to the user and provides additional control options without cluttering the user interface with additional displayed controls.

In some embodiments, the computer system (e.g., 600) is connected to the telephone call with a second computer system. In some embodiments, in accordance with a determination that the second computer system satisfies one or more criteria (e.g., a second computer system corresponds to a device type and/or a second computer system is running an operating system type): the computer system causes a prompt to be displayed at the second computer system, wherein the prompt indicates that the archive will be created when an amount of time elapses (e.g., 3 seconds, 4 seconds, and/or 5 seconds). In some embodiments, the prompt is caused to be provided when the recording and/or transcription is created. Causing a prompt to be displayed at the second computer system indicating that the archive will be created when an amount of time passes if the second computer system satisfies one or more criteria improves visual feedback to the user and reduces the number of inputs needed to perform an operation.

In some embodiments, archiving the telephone call includes recording audio corresponding to the telephone call and the archive includes an audio recording of the telephone call. In some embodiments, after recording the audio corresponding to the telephone call has ended (e.g., ended based on an end to the telephone call and/or ended based on an input detected on an option to end the recording), the computer system (e.g., 600) displays a file (e.g., 630, 694, user-editable data, an electronic note, and/or information stored on the computer system) corresponding to the recording, wherein the file includes a user interface element (e.g., 634 and/or 698) with an option (e.g., 644, a selectable user interface element, an icon, a button, an affordance, a selectable option, and/or a user-interactive user interface element) to initiate playback of the recording. In some embodiments, user interface element includes a name and/or phone number of a second computer system associated with the recording. In some embodiments, user interface element includes a summary and/or preview corresponding to the recording. In some embodiments, user interface element includes a date and/or time associated with the recording. In some embodiments, user interface element includes a duration corresponding to a duration of the recording. In some embodiments, the computer system detects, via the one or more input devices, an input directed to the option to initiate playback of the recording. In some embodiments, in response to detecting, via the one or more input devices, an input directed to the option to initiate playback of the recording, the computer system initiates playback of the recording. In some embodiments, the file includes text, photos, videos, and/or links (e.g., hyperlinks) to additional content accessible at the computer system and/or a remote system (e.g., via the internet). In some embodiments, the file is created, modified, updated, and or deleted by a user of the computer system. In some embodiments, the file is accessible via one or more applications on the computer system. In some embodiments, the file is sharable with one or more additional computer systems. Displaying a file corresponding to the recording including a user interface element with an option to initiate playback of the recording after the recording has ended improves visual feedback to the user and reduces the number of inputs needed to perform an operation.

The computer system (e.g., 600) displays, via the one or more display generation components (e.g., 602), a list (e.g., a list of recent calls, incoming calls, outgoing calls, and/or missed calls) including a telephone call log associated with a telephone call (e.g., 660), wherein the telephone call log includes an indication of an archive (e.g., 664) corresponding to the telephone call (e.g., an option to navigate to the archive and/or a preview associated with the archive). Displaying a list including a telephone call log including an indication of an archive corresponding to the telephone call improves visual feedback to the user and reduces the number of inputs needed to perform an operation.

In some embodiments, the computer system (e.g., 600) is connected to the telephone call with a second computer system. In some embodiments, in accordance with a determination that a contact corresponding to the second computer system is known (e.g., a contact stored on the computer system and/or a contact stored on an account associated with the computer system), the computer system displays, via the one or more display generation components (e.g., 602), a name associated with the contact, wherein the name is displayed in a file (e.g., user-editable data and/or information stored on the computer system) corresponding to the archive (e.g., the name is displayed above, below, within, and/or adjacent to a user interface element corresponding to the archive). In some embodiments, the file includes text, photos, videos, and/or links (e.g., hyperlinks) to additional content accessible at the computer system and/or a remote system (e.g., via the internet). In some embodiments, the file is created, modified, updated, and or deleted by a user of the computer system. In some embodiments, the file is accessible via one or more applications on the computer system. In some embodiments, the file is sharable with one or more additional computer systems. Displaying a file corresponding to the archive including a name associated with a contact corresponding to the second computer system in accordance with a determination that the contact is known improves visual feedback to the user.

In some embodiments, the computer system (e.g., 600) is connected to the telephone call with a second computer system. In some embodiments, in accordance with a determination that a contact corresponding to the second computer system is unknown (e.g., there is no contact stored on the computer system corresponding to a phone number of the second computer system and/or there is no contact stored on an account associated with the computer system corresponding to a phone number of the second computer system), the computer system displays, via the one or more display generation components (e.g., 602), a phone number associated with the second computer system, wherein the phone number is displayed in a file (e.g., user-editable data and/or information stored on the computer system) corresponding to the archive (e.g., the phone number is displayed above, below, within, and/or adjacent to a user interface element corresponding to the archive). In some embodiments, in accordance with a determination that a contact corresponding to the second computer system is known, the computer system displays, via the one or more display generation components (e.g., 602), the phone number associated with the second computer system. In some embodiments, the file includes text, photos, videos, and/or links (e.g., hyperlinks) to additional content accessible at the computer system and/or a remote system (e.g., via the internet). In some embodiments, the file is created, modified, updated, and or deleted by a user of the computer system. In some embodiments, the file is accessible via one or more applications on the computer system. In some embodiments, the file is sharable with one or more additional computer systems. Displaying a file corresponding to the archive including a phone number associated with a second party to the telephone call improves visual feedback to the user.

In some embodiments, the computer system (e.g., 600) displays, via the one or more display generation components (e.g., 602), an option (e.g., a selectable user interface element, an icon, a button, an affordance, a selectable option, and/or a user-interactive user interface element) to enable or disable display of the option for archiving a telephone call (e.g., 606 and/or 674) (e.g., an option is displayed within a device settings menu and/or an option is displayed within a telephone call options menu). In some embodiments, while the computer system is connected to a second telephone call: in accordance with a determination that the option to enable or disable display of the option for archiving a telephone call is enabled, the computer system displays, via the one or more display generation components, an option (e.g., a selectable user interface element, an icon, a button, an affordance, a selectable option, and/or a user-interactive user interface element) for archiving the second telephone call. In some embodiments, in accordance with a determination that the option to enable or disable display of the option for archiving a telephone call is disabled, the computer system forgoes displaying, via the one or more display generation components, the option for archiving the second telephone call (e.g., displaying the telephone call user interface without displaying the option for archiving the second telephone call). Displaying an option for archiving a telephone call based on an option to enabled or disable display the option for archiving the telephone call improves visual feedback to the user and provides additional control options without cluttering the user interface with additional displayed controls.

In some embodiments, a file (e.g., 630, 694, user-editable data and/or information stored on the computer system) corresponding to the archive is accessible by a second computer system, wherein the second computer system has access, via the file, to at least one of an audio recording of the telephone call and a transcription of the telephone call. In some embodiments, if the audio recording of the telephone call is active, the second computer system has access to a pending duration of the recording. In some embodiments, if the transcription of the telephone call is active, the second computer system has access to an ongoing transcription. In some embodiments, the file includes text, photos, videos, and/or links (e.g., hyperlinks) to additional content accessible at the computer system (e.g., 600) and/or a remote system (e.g., via the internet). In some embodiments, the file is created, modified, updated, and or deleted by a user of the computer system. In some embodiments, the file is accessible via one or more applications on the computer system. In some embodiments, the file is sharable with one or more additional computer systems. Providing access for a second computer system to the file corresponding to the archive reduces the number of inputs needed to perform an operation.

In some embodiments, a file (e.g., 630, 694, user-editable data, an electronic note, and/or information stored on the computer system) corresponding to the archive is displayed, via the one or more displayed generation components, with a user interface element in a first state (e.g., the user interface element indicates an audio recording of the telephone call is in progress and/or the user interface element indicates a transcription of the telephone call is in progress). In some embodiments, the file includes text, photos, videos, and/or links (e.g., hyperlinks) to additional content accessible at the computer system (e.g., 600) and/or a remote system (e.g., via the internet). In some embodiments, the file is created, modified, updated, and or deleted by a user of the computer system. In some embodiments, the file is accessible via one or more applications on the computer system. In some embodiments, the file is sharable with one or more additional computer systems. In some embodiments, after archival of the telephone call has ended (e.g., the archival ends based on an end to the telephone call and/or the archival ends based on an input detected on an option to end the archival), the computer system displays, via the one or more displayed generation components, the file with the user interface element in a second state different from the first state (e.g., the user interface element includes an audio recording duration, a preview of a transcription, and/or an option to play an audio recording). Displaying the file with the user interface element in a second state different from the first state after archival of the telephone call has ended improves visual feedback to the user and reduces the number of inputs needed to perform an operation.

In some embodiments, after archival of the telephone call has ended (e.g., ended based on an end to the telephone call and/or ended based on an input detected on an option to end the archival), the computer system (e.g., 600) displays, via the one or more display generation components (e.g., 602), a file (e.g., 630, 694, user-editable data and/or information stored on the computer system) including a user interface element (e.g., 634 and/or 698), wherein the file corresponds to the archive. In some embodiments, the file includes text, photos, videos, and/or links (e.g., hyperlinks) to additional content accessible at the computer system and/or a remote system (e.g., via the internet). In some embodiments, the file is created, modified, updated, and or deleted by a user of the computer system. In some embodiments, the file is accessible via one or more applications on the computer system. In some embodiments, the file is sharable with one or more additional computer systems. In some embodiments, the computer system detects, via the one or more input devices, an input (e.g., tap input and/or long press input) directed to (e.g., on or at) the user interface element, and in response to detecting the input directed to the user interface element, the computer system displays a user interface including details corresponding to the archive (e.g., 650) (e.g., details including an option to view a transcription, a transcription, an option to play an audio recording, an option to summarize an audio recording, and/or an option to summarize a transcription). Displaying a user interface including details corresponding to the archive in response to detecting an input directed to the user interface element improves visual feedback to the user and reduces the number of inputs needed to perform an operation.

In some embodiments, creating an archive based on audio corresponding to the telephone call includes, while the computer system (e.g., 600) is connected to the telephone call (e.g., a telephone call with one other party or a telephone call with multiple parties), displaying, via the one or more display generation components (e.g., 602), a transcription of speech included in the audio corresponding to the telephone call (e.g., 654, a transcription including a name of a user of the computer system with corresponding speech of the user of the computer system, a transcription including a name of a second user of a second computer system with corresponding speech of the sed user of the second computer system, wherein the second computer system is a party to the telephone call). In some embodiments, the transcription is provided on the telephone call user interface (e.g., 604 and/or 672). In some embodiments, the transcription is provided within a file corresponding to the transcription. Displaying a transcription of speech included in the audio corresponding to the telephone call while the computer system is connected to the telephone call improves visual feedback to the user and reduces the number of inputs needed to perform an operation.

FIGS. 8A-8U illustrate exemplary user interfaces for audio recording, in accordance with some embodiments. The user interfaces in these figures are used to illustrate the processes described below, including the processes in FIG. 9.

FIGS. 8A-80 illustrate computer system 600. Computer system 600 includes one or more display generation components 602. In FIG. 8A, computer system 600 displays, via the one or more display generation components 602, note file 804. In some embodiments, note file 804 corresponds to note file 630. Note file 804 includes text 806 entered into computer 600 by a user (e.g., via a virtual keyboard and/or a dictation function). Note file 804 includes an option 808 to record audio, such as audio from an environment surrounding computer system 600. In response to detecting input 810 directed to option 808 to record audio, a recording interface is displayed as shown in FIG. 8B.

With reference to FIG. 8B, recording interface 812 is displayed in response to input 810 directed to option 808 to record audio. In some embodiments, recording of the audio from the environment surrounding computer system 600 commences in response to detection of input 810. In some embodiments, recording interface 812 is displayed without recording of audio commencing. Recording interface 812 includes playback controls 814. In some embodiments, playback controls 814 are enabled when recording is inactive and are disabled when recording is active. Recording interface 812 also includes a playback position indication 816 corresponding to a current position in a recording and/or a playback of a recording. Recording interface 812 further includes a record option 814. In some embodiments, in response to detection of an input directed to record option 814, recording of the audio of the environment commences.

With reference to FIG. 8C, recording interface 812 is shown after recording of audio has commenced. For example, playback position indication 816 indicates that three minutes and 27 second have elapsed since audio recording commenced. Recording interface 812 is dismissed in response to detecting input 818 (e.g., a swipe and/or scroll motion), as discussed in more detail with respect to FIG. 8I. Recording interface 812 includes a transcription option 820 for providing an ongoing transcription of the audio recording. In response to detection of input 822 on transcription option 820, a transcription is displayed as discussed with respect to FIG. 8D.

With reference to FIG. 8D, in response to detection of input 822 on transcription option 820, recording interface 812 is displayed with transcription 824. While the audio being recorded includes speech input, transcription 824 corresponds to an ongoing transcription of the audio being recorded. For example, playback position indication 816 indicates that a current time of the recording is eight minutes and 27 seconds. For instance, the transcription portion 824 including text “Let's look at the industrialized world since the mid 19th century starting with the United States” corresponds to speech recorded at or around eight minutes and 27 seconds into the audio recording. In response to detection of input 822 on transcription option 820, recording interface 812 includes a summarize option 826. In response to detection of input 828 on summarize option 826, a summary is shown as discussed in more detail with respect to FIG. 8H.

With reference to FIG. 8E, recording interface 812 is displayed with playback position indication showing that the current position of the recording has advanced to 18 minutes and 27 seconds. While speech is transcribed during the recording, transcription 824 is displayed as scrolling as the transcription is created (e.g., scrolling downward). Recording interface 812 also includes an option 830 to pause the recording. In response to detection of input 832 on option 830 to pause the recording, recording of the audio ceases.

With reference to FIG. 8F, in response to detection of input 832 on option 830 to pause the recording, recording of audio ceases and option 830 to pause the recording is replaced with option 834 to resume recording. In some embodiments, a state of option 834 to resume recording is based on a position of transcription 824. For example, if the position of transcription is not the end of the transcription (e.g., the beginning of the transcription or the middle of the transcription), option 834 to resume recording is disabled. If the position of transcription is the end of the transcription, option 834 to resume recording is enabled. In response to detection of input 832 on option 830 to pause the recording, playback controls 814 become enabled. In response to detection of an input on one or more playback controls 814, playback of the recording is initiated (e.g., the audio is played in response to input on a play control, the audio is rewound in response to input on a rewind control, and/or the audio is advanced in response to input on a fast forward control). In response to detection of input 836 on transcription 824 (e.g., a swipe and/or scroll gesture), a position of transcription 824 is adjusted as shown in FIG. 8G.

With reference to FIG. 8G, recording interface 812 is displayed with the position of transcription 824 modified based on input 836. For example, input 836 corresponds to a motion to scroll to the bottom of transcription 824. Accordingly, option 834 to resume recording becomes enabled in response to detection of input 836. In response to an input on option 834 to resume recording, recording of audio within the environment of computer system 600 resumes at the position that recording previously ended. In response to detection of input 828 on summarize option 826, a summary is shown as discussed in more detail with respect to FIG. 8H.

With respect to FIG. 8H, summary 838 is displayed in response to detection of input 828 on summarize option 826. Summary 838 includes bullet points, paragraphs, sentences, and/or other information summarizing the content from transcription 824. Summary 828 is generated at computer system 600 and/or is obtained from a remote source (e.g., a server).

With reference to FIG. 8I, note file 804 is displayed in response to detection of input 818 (e.g., a swipe and/or scroll motion) to dismiss recording interface 812 during an ongoing recording (with reference back to FIG. 8C). In some embodiments, while recording is ongoing, note 804 includes text 806 entered into computer system 600 by a user (e.g., via a virtual keyboard and/or a dictation function), and also includes user interface element 840 corresponding to the ongoing recording. User interface element 840 includes a title of the recording (“New Recording”), a current position indicating a record time (“three minutes”), and an option 842 to pause the recording.

With reference to FIG. 8J, note file 804 is displayed with a current position indicating a record time of 12 minutes via user interface element 840. While the recording of audio is active, text 844 entered into computer system 600 by a user (e.g., via a virtual keyboard and/or a dictation function) is shown below user interface element 840. Text may be typed and/or dictated into note file 804 while recording is occurring, before recording begins, and/or after recording ends. In response detection of input 846 directed to option 842 to pause the recording, audio recording ceases.

With reference to FIG. 8K, in response to detection of input 846 directed to option 842 to pause the recording, audio recording ceases and an appearance of user interface element 840 is modified. For example, user interface element 840 includes additional information relative to when the audio recording was in progress. User interface element 840 includes a name of the recording (“New Recording”), a date and/or time corresponding to the recording, a preview of the recording, and/or playback option 848 to initiate playback of the recording. In response to input 850 on playback option 848, playback of the audio commences.

With reference to FIG. 8L, in response to input 850 on playback option 848, playback of the audio commences and playback option 848 changes in appearance to one or more playback controls for rewinding, pausing, and/or fast forwarding the audio playback. In some embodiments, an input 852 on user interface element 840 is detected (e.g., an input directed to an area of user interface element 840 that does not correspond to playback option 848). In response to detection of input corresponding to selection of content (e.g., via a virtual keyboard and/or a dictation function) entered into note 804, additional text is populated into text 844, such as “Remember to send audio to John.” In response to detection of input 648, an audio recording details interface is displayed, as discussed in more detail with respect to FIG. 6N. Detection of input 854, such as a scrolling motion, causes display of note 840 to scroll downwards as show in FIG. 8M.

With reference to FIG. 8M, in response to detection of input 854, note 840 is displayed as scrolled to the bottom of note 840. If audio playback is active and a scrolling motion causes user interface element 840 to no longer be displayed, playback controls 844 remain displayed, for example, at a bottom of note 840.

With reference to FIG. 8N, in response to detection of input 648, an audio recording details interface 856 is displayed. Audio recording details interface 856 includes an option 858 to summarize the audio recording, transcription 860 corresponding to the audio recording, and playback controls 862 to play back the audio recording. In response to detection of an input 864 on an option to play the audio recording, audio playback of the recording commences.

With reference to FIG. 8O, in response to detection of an input 864 on an option to play the audio recording, audio playback of the recording commences. For instance, playback position indicator 866 indicates that 15 seconds have elapsed in the audio playback. In addition, transcription 860 is displayed with an indication of a current position in the audio playback based on highlighted text 860a. For example, highlighted text 860a corresponds to a position in the transcription associated with a current playback position, such as 15 seconds into the audio recording.

With reference to FIGS. 8P-8U, computer system 800 is depicted. In some embodiments, computer system 800 corresponds to a laptop or desktop computer having one or more display generation components 802. In FIG. 8P, a note interface 868 is displayed via one or more display generation components 802. Note interface 868 includes one or more categories of notes 870a, a currently selected note 870b, and note details 870c corresponding to the currently selected note. In response to detection of input 872 on an option 870d for a new recording, a new recording panel 874 is displayed. New recording panel 874 includes an option 876 to record audio corresponding to a surrounding environment of computer system 800. In response to input 878 on option 876 to record audio, audio recording commences.

With reference to FIG. 8Q, in response to input 878 on option 876 to record audio new recording panel 874 is displayed with a current recording position 880. In this example, current recording position 880 indicates that recording has been ongoing for 41 minutes and ten seconds. In addition, in response to input 878 on option 876 to record audio, note details 870 is displayed with user interface element 882 corresponding to the new recording and including a current recording position, such as 41 minutes. New recording panel 874 also includes a dismiss option 884 to dismiss recording panel 874. In response to detection of input 886 on option 884 to dismiss recording panel 874, recording panel 874 ceases to be displayed as shown in FIG. 8R.

With respect to FIG. 8R, note interface 868 is displayed after detection of input 886 on option 884 to dismiss recording panel 874, such that recording panel 874 is no longer displayed. When recording panel 874 is no longer displayed, user interface element 882 includes playback control 888a to pause audio recording. In response to detection of input 890a on playback control 888a, audio recording is paused. In addition, in response to detection of input 890b (e.g., a double click and/or a right click) on user interface element 882, recording panel 874 is again displayed as depicted in FIG. 8S.

With respect to FIG. 8S, recording panel 874 is displayed while audio recording is paused. When recording has finished and/or is paused, an option 892 to summarize the audio recording is displayed. In response to detection of input 894 on option 892 to summarize the audio recording, a recording summary is displayed as depicted in FIG. 8T.

With reference to FIG. 8T, summary 896 is displayed. Summary 896 is generated at computer system 800 and/or is obtained from a remote source (e.g., a server). In response to detection of input 886 on option 884 to dismiss recording panel 874, recording panel 874 ceases to be displayed as shown in FIG. 8U.

With reference to FIG. 8U, note interface 868 is displayed after detection of input 886 on option 884 to dismiss recording panel 874, such that recording panel 874 is no longer displayed. When recording panel 874 is no longer displayed, user interface element 882 includes playback control 888b to play the audio recording. In response to input 890c on playback control 888b, playback of the audio recording commences.

FIG. 9 is a flow diagram illustrating a method for audio recording and transcription using a computer system in accordance with some embodiments. Method 900 is performed at a computer system (e.g., 100, 300, 500, 600, and/or 800) that is in communication with one or more display generation components (e.g., 602, 802, a display controller, a display, a touch-sensitive display system, a touchscreen, a monitor, and/or a head mounted display system) and one or more input devices (e.g., a touch-sensitive surface, a physical button, a rotatable input mechanism, a rotatable and depressible input mechanism, a motion sensor, an accelerometer, a gyroscope, a keyboard, a controller, and/or a mouse). Some operations in method 900 are, optionally, combined, the orders of some operations are, optionally, changed, and some operations are, optionally, omitted.

As described below, method 900 provides an intuitive way for facilitating audio recording and transcription. The method reduces the cognitive burden on a user when using recording and transcribing audio, thereby creating a more efficient human-machine interface. For battery-operated computing devices, enabling a user to record and transcribe audio faster and more efficiently conserves power and increases the time between battery charges.

The computer system (e.g., 600 and/or 800) detects (902), via the one or more input devices, an input (e.g., 810, a tap input and/or a long press input) directed to (e.g., on or at) an option (e.g., 808, a selectable user interface element, an icon, a button, an affordance, a selectable option, and/or a user-interactive user interface element) to record audio, wherein the option to record audio is displayed within a file (e.g., 804, user-editable data, an electronic note, and/or information stored on the computer system). In some embodiments, the file includes text, photos, videos, and/or links (e.g., hyperlinks) to additional content accessible at the computer system and/or a remote system (e.g., via the internet). In some embodiments, the file is created, modified, updated, and or deleted by a user of the computer system. In some embodiments, the file is accessible via one or more applications on the computer system. In some embodiments, the file is sharable with one or more additional computer systems. In some embodiments, the option to record audio is displayed (e.g., in a menu) with additional options including attaching a file, creating an image, selecting media, scanning a document, taking a photo or video, and/or scanning text. In some embodiments, the option to record audio is displayed in response to detecting selection of an attachment option. In response to detecting the input directed to the option to record audio, the computer system (e.g., 600 and/or 800) displays (904), via the one or more display generation components (e.g., 602), an option (e.g., 818, 876, a selectable user interface element, an icon, a button, an affordance, a selectable option, and/or a user-interactive user interface element) to initiate an audio recording (e.g., a record button displayed within a user interface that is overlaid on the file and/or a record button display within a user interface that replaces display of the file). In some embodiments, the computer system detects (906), via the one or more input devices, an input (e.g., 820, 878, a tap input and/or a long press input) directed to (e.g., on or at) the option to initiate an audio recording. In some embodiments, in response to detecting the input directed to the option to initiate an audio recording, the computer system initiates (908) the audio recording (e.g., creating a new audio file on the computer system and/or creating a new audio file on a second computer system (e.g., a server) accessible by the computer system). Displaying an option to initiate an audio recording in response to detecting an input on an option, within a file, to record audio and initiating the recording in response to detecting an input directed to an option to initiate audio recording improves visual feedback to the user and reduces the number of inputs needed to perform an operation.

In some embodiments, the computer system (e.g., 600 and/or 800) displays, via the one or more display generation components (e.g., 602 and/or 802), an option (e.g., 820, a selectable user interface element, an icon, a button, an affordance, a selectable option, and/or a user-interactive user interface element) to transcribe the audio recording. In some embodiments, at a first time, the computer system detects, via the one or more input devices, an input (e.g., 822, a tap input and/or a long press input) directed to (e.g., on or at) the option to transcribe the audio recording. In some embodiments, in response to detecting the input directed to the option to transcribe the audio recording, the computer system displays, via the one or more display generation components, a transcription of the audio recording (e.g. 824) (e.g., displaying the transcription concurrently with playback controls for the audio recording and/or displaying the transcription overlaid on the audio recording) beginning at a time in the audio recording corresponding to the first time. Displaying a transcription of the audio recording in response to detecting an input directed to the option to transcribe the audio recording improves visual feedback to the user and reduces the number of inputs needed to perform an operation.

In some embodiments, the computer system (e.g., 600 and/or 800) detects, via the one or more input devices, an input (e.g., 832, a tap input and/or a long press input) directed to (e.g., on or at) an option (e.g., 830, a selectable user interface element, an icon, a button, an affordance, a selectable option, and/or a user-interactive user interface element) to pause the audio recording. In some embodiments, in response to detecting the input directed to the option to pause the audio recording, the computer system pauses the audio recording and displays, via the one or more display generation components (e.g., 602), an option (e.g., 834, a selectable user interface element, an icon, a button, an affordance, a selectable option, and/or a user-interactive user interface element) to resume the audio recording (e.g., an option with a textual representation to resume and/or an option with a graphical representation to resume), wherein the option to resume the audio recording includes a graphical representation of a state (e.g., enabled or disabled) of the option to resume the audio recording (e.g., whether a transcription is displayed and/or whether a transcription is at a specific position). Ceasing to continue the audio recording and displaying an option to resume the audio recording in response to detecting an input directed to an option to pause the audio recording improves visual feedback to the user and reduces the number of inputs needed to perform an operation.

In some embodiments, the state of the option to resume the audio recording is disabled (e.g., a selection of the option to resume does not result in any action and/or an appearance of the option to resume includes a flattened and/or blurred appearance) in accordance with a determination that a position of the transcription does not correspond to the end of the transcription (e.g., the transcription position corresponds to a beginning or middle of the transcription and/or the transcription is not displayed). Providing the option to resume the audio recording in a disabled state if a position of the transcription does not correspond to an end of the transcription improves visual feedback to the user and reduces the number of inputs needed to perform an operation.

In some embodiments, the state of the option to resume the audio recording is enabled (e.g., selection of the option to resume causes the audio recording to resume and/or an appearance of the option to resume includes a raised and/or clear appearance) in accordance with a determination that a position of the transcription corresponds to the end of the transcription. Providing the option to resume the audio recording in an enabled state if a position of the transcription corresponds to an end of the transcription improves visual feedback to the user and reduces the number of inputs needed to perform an operation.

In some embodiments, while a transcription of the audio recording is being displayed, the computer system (e.g., 600 and/or 800) displays, via the one or more display generation components (e.g., 602), an option (e.g., a selectable user interface element, an icon, a button, an affordance, a selectable option, and/or a user-interactive user interface element) to pause the audio recording. In some embodiments, detecting, via the one or more input devices, an input (e.g., tap input and/or long press input) directed to (e.g., on or at) the option to pause the audio recording. In some embodiments, in response to detecting the input directed to the option to pause the audio recording: the computer system pauses the audio recording and the computer system displays, via the one or more display generation components, an option (e.g., 858, 892, a selectable user interface element, an icon, a button, an affordance, a selectable option, and/or a user-interactive user interface element) to summarize (e.g., using an AI process or a generative AI process) the transcription of the audio recording (e.g., an option with a textual representation to transcribe and/or an option with a graphical representation to transcribe). In some embodiments, the computer system detects an input corresponding to a selection of the option to summarize (e.g., using an AI process or a generative AI process) the transcription of the audio recording (e.g., 828), and in response to detecting the input corresponding to a selection of the option to summarize the transcription of the audio recording, the computer system generates and/or displays a summary (e.g., automatically-generated text content and or generative text content) of the transcription of the audio recording. Ceasing to continue the audio recording and displaying an option to summarize the transcription of the audio recording in response to detecting an input directed to an option to pause the audio recording improves visual feedback to the user and reduces the number of inputs needed to perform an operation.

In some embodiments, while a transcription of the audio recording is being displayed, the computer system (e.g., 600 and/or 800) detects, via the one or more input devices, an input (e.g., 828, a tap input and/or a long press input) directed to (e.g., on or at) an option (e.g., 858, 892, a selectable user interface element, an icon, a button, an affordance, a selectable option, and/or a user-interactive user interface element) to summarize (e.g., using an AI process or a generative AI process) the transcription of the audio recording. In some embodiments, in response to detecting the input directed to the option to summarize the transcription of the audio recording, the computer system displays, via the one or more display generation components (e.g., 602), a summary (e.g., automatically-generated text content and or generative text content) of the audio recording (e.g., 838) (e.g., a user interface including the summary is displayed as overlaid on the transcription; e.g., a user interface including the summary is displayed concurrently with the transcription; e.g., summary is generated at the computer system; e.g., summary is generated at a server and transmitted to the computer system). Displaying a summary (e.g., automatically-generated text content and or generative text content) of the audio recording in response to detecting an input directed to the option to summarize (e.g., using an AI process or a generative AI process) the transcription of the audio recording improves visual feedback to the user and reduces the number of inputs needed to perform an operation.

In some embodiments, in response to detecting the input directed to the option to initiate an audio recording, the computer system (e.g., 600 and/or 800) displays, via the one or more display generation components (e.g., 602 and/or 802), a user interface including a current duration of the audio recording. In some embodiments, a user interface is displayed with an audio waveform corresponding to an amplitude of corresponding positions of the audio recording. In some embodiments, a user interface is displayed with a start time of the audio recording. In some embodiments, the computer system detects, via the one or more input devices, an input including a gesture in a first direction (e.g., swipe down and/or swipe up). In some embodiments, in response to detecting the input including the gesture in the first direction, the computer system displays, via the one or more display generation components (e.g., 602 and/or 802), a file (e.g., user-editable data, an electronic note, and/or information stored on the computer system) including a user interface element (e.g., 840 and/or 882) with an option (e.g., 842, a selectable user interface element, an icon, a button, an affordance, a selectable option, and/or a user-interactive user interface element) to pause the audio recording. In some embodiments, a user interface element includes a current duration of the audio recording. In some embodiments, the file includes text, photos, videos, and/or links (e.g., hyperlinks) to additional content accessible at the computer system and/or a remote system (e.g., via the internet). In some embodiments, the file is created, modified, updated, and or deleted by a user of the computer system. In some embodiments, the file is accessible via one or more applications on the computer system. In some embodiments, the file is sharable with one or more additional computer systems. Displaying a file including a user interface element with an option to pause the audio recording in response to detecting an input including a gesture in a first direction reduces the number of inputs needed to perform an operation.

In some embodiments, while a file (e.g., 804, user-editable data, an electronic note, and/or information stored on the computer system) including the user interface element (e.g., 840 and/or 882) is displayed, the computer system (e.g., 600 and/or 800) detects, via the one or more input devices, a set of one or more user inputs including selection of one or more characters (e.g., input to a virtual keyboard and/or speech input converted to text). In some embodiments, the file includes text, photos, videos, and/or links (e.g., hyperlinks) to additional content accessible at the computer system and/or a remote system (e.g., via the internet). In some embodiments, the file is created, modified, updated, and or deleted by a user of the computer system. In some embodiments, the file is accessible via one or more applications on the computer system. In some embodiments, the file is sharable with one or more additional computer systems. In some embodiments, in response to detecting the set of one or more user inputs including selection of the one or more characters, the computer system displays, via the one or more display generation components, the one or more characters within the file (e.g., displaying the characters above the user interface element and/or displaying the characters below the user interface element). Displaying one or more characters within a file in response to detecting user input including one or more characters reduces the number of inputs needed to perform an operation.

In some embodiments, the computer system (e.g., 600 and/or 800) displays, via the one or more display generation components (e.g., 602 and/or 802), a file (e.g., 804, user-editable data, an electronic note, and/or information stored on the computer system) including a user interface element (e.g., 840 and/or 882) with an option (e.g., 842, a selectable user interface element, an icon, a button, an affordance, a selectable option, and/or a user-interactive user interface element) to pause the audio recording. In some embodiments, the file includes text, photos, videos, and/or links (e.g., hyperlinks) to additional content accessible at the computer system and/or a remote system (e.g., via the internet). In some embodiments, the file is created, modified, updated, and or deleted by a user of the computer system. In some embodiments, the file is accessible via one or more applications on the computer system. In some embodiments, the file is sharable with one or more additional computer systems. In some embodiments, the computer system detects, via the one or more input devices, an input (e.g., tap input and/or long press input) directed to (e.g., on or at) the option to pause the audio recording. In some embodiments, in response to detecting the input directed to the option to pause the audio recording, the computer system displays, via the one or more display generation components, the file including the user interface element with an option (e.g., a selectable user interface element, an icon, a button, an affordance, a selectable option, and/or a user-interactive user interface element) to play the audio recording (e.g., the option to play the audio recording replaces the option to pause the audio recording and/or the option to pause the audio recording is disabled when the option to play the audio recording is displayed). In some embodiments, in response to detecting the input directed to the option to pause the audio recording, the user interface element is displayed with a preview (e.g., automatically-generated text content and or generative text content) of the audio recording. Displaying the file including the user interface element with an option to play the audio recording in response to detecting the input directed to the option to pause the audio recording reduces the number of inputs needed to perform an operation.

In some embodiments, while the file (e.g., 804) including the user interface element (e.g., 840 and/or 882) with an option (e.g., a selectable user interface element, an icon, a button, an affordance, a selectable option, and/or a user-interactive user interface element) to play the audio recording is displayed, the computer system (e.g., 600 and/or 800) displays a preview (e.g., automatically-generated text content and or generative text content) of the audio recording (e.g., displaying a number of characters corresponding to the beginning of a transcription of the audio recording and/or displaying a number of characters corresponding to a summary of the audio recording). In some embodiments, while a transcription of the audio recording is being displayed, the computer system displays, via the one or more display generation components (e.g., 602 and/or 802), a summary (e.g., automatically-generated text content and or generative text content) of the audio recording in response to detecting, via the one or more input devices, an input (e.g., tap input and/or long press input) directed to (e.g., on or at) an option (e.g., 858, 892, a selectable user interface element, an icon, a button, an affordance, a selectable option, and/or a user-interactive user interface element) to summarize (e.g., using an AI process or a generative AI process) the transcription of the audio recording, wherein the preview (e.g., automatically-generated text content and or generative text content) of the audio recording is different from the summary (e.g., automatically-generated text content and or generative text content) of the audio recording (e.g., the preview has less characters and/or less words than the summary). Displaying a preview (e.g., automatically-generated text content and or generative text content) of the audio recording which is different than the summary of the audio recording provides improved visual feedback to the user.

FIG. 10 is a flow diagram illustrating a method for audio recording and transcription using a computer system in accordance with some embodiments. Method 1000 is performed at a computer system (e.g., 100, 300, 500, 600, and/or 800) that is in communication with one or more display generation components (e.g., 602, 802, a display controller, a display, a touch-sensitive display system, a touchscreen, a monitor, and/or a head mounted display system) and one or more input devices (e.g., a touch-sensitive surface, a physical button, a rotatable input mechanism, a rotatable and depressible input mechanism, a motion sensor, an accelerometer, a gyroscope, a keyboard, a controller, and/or a mouse). Some operations in method 1000 are, optionally, combined, the orders of some operations are, optionally, changed, and some operations are, optionally, omitted.

As described below, method 1000 provides an intuitive way for facilitating audio recording and transcription. The method reduces the cognitive burden on a user when using recording and transcribing audio, thereby creating a more efficient human-machine interface. For battery-operated computing devices, enabling a user to record and transcribe audio faster and more efficiently conserves power and increases the time between battery charges.

In some embodiments, the computer system (e.g., 600 and/or 800) displays (1002), via the one or more display generation components (e.g., 602 and/or 802), a file (e.g., user-editable data, an electronic note, and/or information stored on the computer system) including a user interface element with an option (e.g., a selectable user interface element, an icon, a button, an affordance, a selectable option, and/or a user-interactive user interface element) to play an audio recording (e.g., the user interface element includes a timestamp corresponding to a beginning of the recording or an end of the recording; e.g., user interface element includes a preview of the audio recording). In some embodiments, a preview (e.g., automatically-generated text content and or generative text content) of the audio recording is generated at the computer system. In some embodiments, the file includes text, photos, videos, and/or links (e.g., hyperlinks) to additional content accessible at the computer system and/or a remote system (e.g., via the internet). In some embodiments, the file is created, modified, updated, and or deleted by a user of the computer system. In some embodiments, the file is accessible via one or more applications on the computer system. In some embodiments, the file is sharable with one or more additional computer systems. The computer system (e.g., 600 and/or 800) detects (1004), via the one or more input devices, an input (e.g., tap input and/or long press input) directed to (e.g., on or at) the user interface element. In some embodiments the input is not directed to the option to play the audio recording. In response to detecting the input directed to the user interface element, the computer system (e.g., 600 and/or 800) displays (1006), via the one or more display generation components (e.g., 602 and/or 802), a user interface corresponding to the audio recording (e.g., 812, 874, the user interface includes audio playback controls, an option to transcribe the audio recording, an option to summarize (e.g., using an AI process or a generative AI process) the audio recording, and/or a duration of the audio recording). Displaying a user interface corresponding to an audio recording in response to detecting an input directed to a user interface element within a file provides improved visual feedback to the user and provides additional control options without cluttering the user interface with additional displayed controls.

In some embodiments, the computer system (e.g., 600 and/or 800) detects, via the one or more input devices, an input (e.g., 850, 890c, a tap input and/or a long press input) directed to (e.g., on or at) the option to play (e.g., 848 and/or 888b) an audio recording. In some embodiments, in response to detecting the input directed to the option to play the audio recording: the computer system initiates playback of the audio recording (e.g., displaying a current time in the playback of the audio recording), and displays, via the one or more display generation components (e.g., 602), playback controls (e.g., 814 and/or 880) corresponding to the playback of the audio recording (e.g., a playback speed control, a rewind control, a pause control, and/or a fast forward control). Initiating playback of the audio recording and displaying playback controls corresponding to playback of the audio recording in response to detecting input directed to the option to play the audio recording provides improved visual feedback to the user and provides additional control options without cluttering the user interface with additional displayed controls.

In some embodiments, the user interface corresponding to the audio recording includes an option (e.g., 858, 892, a selectable user interface element, an icon, a button, an affordance, a selectable option, and/or a user-interactive user interface element) to summarize (e.g., using an AI process or a generative AI process) the audio recording. In some embodiments, in response to detecting an input directed to the option to summarize (e.g., using an AI process or a generative AI process) the audio recording, displaying a summary (e.g., automatically-generated text content and or generative text content) of the audio recording (e.g., 838) (e.g., displaying an interface with a summary replacing the user interface corresponding to the audio recording and/or displaying an interface with a summary concurrently with the user interface corresponding to the audio recording). Providing an option to summarize (e.g., using an AI process or a generative AI process) an audio recording reduces the number of inputs required to perform an operation.

In some embodiments, the computer system (e.g., 600) displays, via the one or more display generation components (e.g., 602), the user interface corresponding to the audio recording with a set of one or more playback controls (e.g., 814 and/or 880), including a first playback control (e.g., a playback speed control, a rewind control, a pause control, and/or a fast forward control), and with a transcription corresponding to the audio recording. In some embodiments, the computer system detects, via the one or more input devices, an input (e.g., tap input and/or long press input) directed to (e.g., on or at) the first playback control. In some embodiments, in response to detecting the input directed to the first playback control, the computer system modifies a position of the transcription (e.g., advancing a position of the transcription or rewinding a position of the transcription) in accordance with a playback function corresponding to the playback control (e.g., fast forward or rewind). In some embodiments, the transcription includes first highlighted text at a current playback position corresponding to audio playback, wherein in response to modifying the position of the transcription, the transcription includes second highlighted text different from the first highlighted text. Modifying a position of the transcription in accordance with a playback function corresponding to input on a playback control reduces the number of inputs required to perform an operation.

In some embodiments, while a transcription of the audio recording is being displayed, the computer system (e.g., 600) detects, via the one or more input devices, an input (e.g., tap input and/or long press input) directed to (e.g., on or at) an option (e.g., 858, 892, a selectable user interface element, an icon, a button, an affordance, a selectable option, and/or a user-interactive user interface element) to summarize (e.g., using an AI process or a generative AI process) the transcription of the audio recording. In some embodiments, in response to detecting the input directed to the option to summarize (e.g., using an AI process or a generative AI process) the transcription of the audio recording, the computer system displays, via the one or more display generation components, a summary (e.g., automatically-generated text content and or generative text content) of the audio recording (e.g., a user interface including the summary is displayed as overlaid on the transcription; e.g., a user interface including the summary is displayed concurrently with the transcription; e.g., the summary is generated at the computer system; e.g., the summary is generated at a server and transmitted to the computer system). Displaying a summary (e.g., automatically-generated text content and or generative text content) of the audio recording in response to detecting an input directed to an option to summarize (e.g., using an AI process or a generative AI process) the transcription of the audio recording reduces the number of inputs required to perform an operation.

In some embodiments, while the file including the user interface element with an option (e.g., 848, 888b, a selectable user interface element, an icon, a button, an affordance, a selectable option, and/or a user-interactive user interface element) to play the audio recording is displayed, the computer system (e.g., 600) displays a preview (e.g., automatically-generated text content and or generative text content) of the audio recording (e.g., displaying a number of characters corresponding to the beginning of a transcription of the audio recording and/or displaying a number of characters corresponding to a summary (e.g., automatically-generated text content and or generative text content) of the audio recording). In some embodiments, while a transcription of the audio recording is being displayed within the user interface corresponding to the audio recording, the computer system displays, via the one or more display generation components (e.g., 602), a summary of the audio recording in response to detecting, via the one or more input devices, an input (e.g., tap input and/or long press input) directed to (e.g., on or at) an option (e.g., 858, 892, a selectable user interface element, an icon, a button, an affordance, a selectable option, and/or a user-interactive user interface element) to summarize (e.g., using an AI process or a generative AI process) the transcription of the audio recording, wherein the preview (e.g., automatically-generated text content and or generative text content) of the audio recording is different than the summary (e.g., automatically-generated text content and or generative text content) of the audio recording (e.g., the preview has less characters and/or less words than the summary). Displaying a preview (e.g., automatically-generated text content and or generative text content) of the audio recording which is different than the summary of the audio recording provides improved visual feedback to the user.

In some embodiments, the user interface corresponding to the audio recording includes a transcription option (e.g., 820, a selectable user interface element, an icon, a button, an affordance, a selectable option, and/or a user-interactive user interface element) in an enabled state (e.g., the transcription option is enabled in response to detecting an input on a disabled transcription option) or in a disabled state (e.g., the transcription option is disabled in response to initiating a recording and/or in response to detecting an input on an enabled transcription option). Providing a transcription option in an enabled or disabled state provides improved visual feedback to the user and reduces the number of inputs required to perform an operation.

In some embodiments, while the transcription option (e.g., 820) is in an enabled state (e.g., the enabled state includes an appearance of a depressed and/or activated button), the computer system (e.g., 600) detects, via the one or more input devices, an input (e.g., 822) directed to the transcription option. In some embodiments, in response to detecting the input directed to the transcription option, the computer system ceases to display of a transcription corresponding to the audio recording, and displays, via the one or more display generation components (e.g., 602 and/or 802), an adjustable playback position corresponding to the audio recording (e.g., a slider bar and/or vertical line displayed adjacent to a horizontal time range). In some embodiments, in response to detecting an input on the adjustable playback position in a reverse direction, rewinding the playback position of the audio recording. In some embodiments, in response to detecting an input on the adjustable playback position in a forward direction, advancing the playback position of the audio recording. Ceasing to display the transcription and displaying an adjustable playback position corresponding to the audio recording in response to detecting an input directed to an enabled transcription option provides improved visual feedback to the user and reduces the number of inputs required to perform an operation.

In some embodiments, while the transcription option (e.g., 820) is in a disabled state (e.g., the disabled state includes an appearance of a raised and/or de-activated button), the computer system (e.g., 600 and/or 800) detects, via the one or more input devices, an input (e.g., 822) directed to the transcription option. In some embodiments, in response to detecting the input directed to the transcription option, the computer system displays, via the one or more display generation components (e.g., 602 and/or 802), a transcription corresponding to the audio recording. In some embodiments, the transcription includes first highlighted text at a current playback position corresponding to audio playback and ceases displaying an adjustable playback position corresponding to the audio recording (e.g., a slider bar and/or vertical line displayed adjacent to a horizontal time range). Ceasing to display an adjustable playback position corresponding to the audio recording and displaying the transcription in response to detecting an input directed to an disabled transcription option provides improved visual feedback to the user and reduces the number of inputs required to perform an operation.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to enhance audio recording and transcription. Accordingly, use of such personal information data enables users to have calculated control audio recording and transcription. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide audio data for audio recording and transcription. In yet another example, users can select to limit the length of time audio data is maintained or entirely prohibit the use of audio data. In addition to providing “opt in” and “opt out” options, the present disclosure contemplates providing notifications relating to audio recording and transcription. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, audio can be recorded and transcribed by inferring preferences based on non-personal information data or a bare minimum amount of personal information, such as the content being requested by the device associated with a user, other non-personal information available to the audio recording and transcription system, or publicly available information.

1-66. (canceled)

67. A computer system configured to communicate with one or more display generation components and one or more input devices, comprising:
one or more processors; and
memory storing one or more programs configured to be executed by the one or more processors, the one or more programs including instructions for:
while the computer system is connected to a telephone call, displaying, via the one or more display generation components, a telephone call user interface;
while displaying the telephone call user interface, in accordance with a determination that archival option criteria are met, displaying, via the one or more display generation components, an option for archiving the telephone call;
detecting, via the one or more input devices, an input directed to the option for archiving the telephone call; and
in response to detecting the input directed to the option for archiving the telephone call, initiating a process for creating an archive based on audio corresponding to the telephone call.

68. The computer system of claim 67, the one or more programs including instructions for:
in response to detecting the input directed to the option for archiving the telephone call, providing a prompt indicating that the archive will be created when an amount of time elapses.

69. The computer system of claim 67, wherein the computer system is connected to the telephone call with a second computer system, the one or more programs including instructions for:
causing a second prompt to be provided at the second computer system, wherein the second prompt indicates that the archive will be created when an amount of time elapses.

70. The computer system of claim 68, wherein:
providing the prompt indicating that the archive will be created when an amount of time elapses includes providing a user interface element, the one or more programs including instructions for:
at a time corresponding to when the amount of time elapses, in accordance with a determination that an input directed to the user interface element has not been detected, creating the archive based on audio corresponding to the telephone call.

71. The computer system of claim 67, the one or more programs including instructions for:
while the telephone call is being archived, providing a periodic prompt indicating that archival of the telephone call is in progress.

72. The computer system of claim 67, the one or more programs including instructions for:
while the computer system is connected to the telephone call, displaying, via the display generation component, a user interface element indicating that the computer system is connected to the telephone call, including:
in accordance with a determination that archival of the telephone call is in progress, displaying the user interface element in a first state; and
in accordance with a determination that archival of the telephone call is not in progress, displaying the user interface element in a second state that is different from the first state.

73. The computer system of claim 67, the one or more programs including instructions for:
in response to creating the archive based on audio corresponding to the telephone call, displaying, via the one or more display generation components, a notification indicating that a file corresponding to the archive has been created.

74. The computer system of claim 73, the one or more programs including instructions for:
detecting, via the one or more input devices, an input directed to the notification indicating that the file corresponding to the archive has been created; and
in response to detecting the input directed to the notification, displaying, via the one or more display generation components, the file corresponding to the archive.

75. The computer system of claim 67, wherein archiving the telephone call includes recording audio corresponding to the telephone call and the archive includes an audio recording of the telephone call, the one or more programs including instructions for:
while the audio recording is being created, displaying, via the one or more display generation components, a file corresponding to the audio recording, wherein the file includes a user interface element that indicates a pending duration of the audio recording.

76. The computer system of claim 67, wherein the determination that the archival option criteria are met includes a determination that the computer system is positioned in a first orientation, the one or more programs including instructions for:
in accordance with a determination that the archival option criteria are not met based on the computer system being positioned in the first orientation, forgoing displaying, via the one or more display generation components, the option for archiving the telephone call.

77. The computer system of claim 76, wherein the archival option criteria include a criterion that is met when the computer system is positioned in the first orientation.

78. The computer system of claim 76, the one or more programs including instructions for:
in accordance with a determination that creating an archive based on audio corresponding to the telephone call has been initiated and a determination that the computer system is positioned in a second orientation that is different from the first orientation, displaying, via the one or more display generation components, an option to end archival of the telephone call.

79. The computer system of claim 67, wherein the computer system is connected to the telephone call with a second computer system, the one or more programs including instructions for:
in accordance with a determination that the second computer system satisfies one or more criteria:
causing a prompt to be displayed at the second computer system, wherein the prompt indicates that the archive will be created when an amount of time elapses.

80. The computer system of claim 67, wherein archiving the telephone call includes recording audio corresponding to the telephone call and the archive includes an audio recording of the telephone call, the one or more programs including instructions for:
after recording the audio corresponding to the telephone call has ended, displaying a file corresponding to the recording, wherein the file includes a user interface element with an option to initiate playback of the recording.

81. The computer system of claim 67, the one or more programs including instructions for:
displaying, via the one or more display generation components, a list including a telephone call log associated with a telephone call, wherein the telephone call log includes an indication of an archive corresponding to the telephone call.

82. The computer system of claim 67, wherein the computer system is connected to the telephone call with a second computer system, the one or more programs including instructions for:
in accordance with a determination that a contact corresponding to the second computer system is known, displaying, via the one or more display generation components, a name associated with the contact, wherein the name is displayed in a file corresponding to the archive.

83. The computer system of claim 67, wherein the computer system is connected to the telephone call with a second computer system, the one or more programs including instructions for:
in accordance with a determination that a contact corresponding to the second computer system is unknown, displaying, via the one or more display generation components, a phone number associated with the second computer system, wherein the phone number is displayed in a file corresponding to the archive.

84. The computer system of claim 67, the one or more programs including instructions for:
displaying, via the one or more display generation components, an option to enable or disable display of the option for archiving a telephone call; and
while the computer system is connected to a second telephone call:
in accordance with a determination that the option to enable or disable display of the option for archiving a telephone call is enabled, displaying, via the one or more display generation components, an option for archiving the second telephone call; and
in accordance with a determination that the option to enable or disable display of the option for archiving a telephone call is disabled, forgoing displaying, via the one or more display generation components, the option for archiving the second telephone call.

85. The computer system of claim 67, wherein a file corresponding to the archive is accessible by a second computer system, wherein the second computer system has access, via the file, to at least one of an audio recording of the telephone call and a transcription of the telephone call.

86. The computer system of claim 67, wherein a file corresponding to the archive is displayed, via the one or more displayed generation components, with a user interface element in a first state, the one or more programs including instructions for:
after archival of the telephone call has ended, displaying, via the one or more displayed generation components, the file with the user interface element in a second state different from the first state.

87. The computer system of claim 67, the one or more programs including instructions for:
after archival of the telephone call has ended, displaying, via the one or more display generation components, a file including a user interface element, wherein the file corresponds to the archive;
detecting, via the one or more input devices, an input directed to the user interface element; and
in response to detecting the input directed to the user interface element, displaying a user interface including details corresponding to the archive.

88. The computer system of claim 67, wherein creating an archive based on audio corresponding to the telephone call includes:
while the computer system is connected to the telephone call, displaying, via the one or more display generation components, a transcription of speech included in the audio corresponding to the telephone call.

89. A method, comprising:
at a computer system that is in communication with one or more display generation components and one or more input devices:
while the computer system is connected to a telephone call, displaying, via the one or more display generation components, a telephone call user interface;
while displaying the telephone call user interface, in accordance with a determination that archival option criteria are met, displaying, via the one or more display generation components, an option for archiving the telephone call;
detecting, via the one or more input devices, an input directed to the option for archiving the telephone call; and
in response to detecting the input directed to the option for archiving the telephone call, initiating a process for creating an archive based on audio corresponding to the telephone call.

90. A non-transitory computer-readable storage medium storing one or more programs configured to be executed by one or more processors of a computer system that is in communication with one or more display generation components and one or more input devices, the one or more programs including instructions for:
while the computer system is connected to a telephone call, displaying, via the one or more display generation components, a telephone call user interface;
while displaying the telephone call user interface, in accordance with a determination that archival option criteria are met, displaying, via the one or more display generation components, an option for archiving the telephone call;
detecting, via the one or more input devices, an input directed to the option for archiving the telephone call; and
in response to detecting the input directed to the option for archiving the telephone call, initiating a process for creating an archive based on audio corresponding to the telephone call.
